(19) United States
(12) Patent Application Publication
(10) Pub. No.: US 2013/0084936 A1
(43) Pub. Date: Apr. 4, 2013

(54) Dice game

(71) Applicant: PROBIS Ltd., Reno, NV (US)

(72) Inventor: Randall David Pease, Reno, NV (US)

(73) Assignee: PROBIS Ltd., Reno, NV (US)

(21) Appl. No.: 13/573,761

(22) Filed: Oct. 3, 2012

Related U.S. Application Data
(60) Provisional application No. 61/542,735, filed on Oct. 3, 2011.

(51) Int. Cl. A63F 9/04; A63F 13/12; A63F 13/10

(52) U.S. Cl. 463/18; 273/146; 273/274

(57) ABSTRACT

A dice game having a first round of play where a dealer rolls a die to create a match number and a player selects one or two modes of play. In the first mode, the player rolls a set of dice trying not to match a die to the match number. If there is no match, the player wins, and if there is a match the player loses. In the second mode, the player only wins and advances if there is a match between one or more die of the dice rolled by the player and the match number. Play continues in the second mode until the player completes a total set number of rounds, winning each time, or loses, but with each round won after the first round, the player has one less die per round to roll.

### CROSS REFERENCE TO RELATED APPLICATIONS

This application claims benefit under 35 U.S.C. §119(e) of Provisional U.S. patent application No. 61/542,735, filed Oct. 3, 2011, the contents of which is incorporated herein by reference in its entirety.

### TECHNICAL FIELD

The subject matter disclosed herein relates to dice games. More specifically, the disclosure relates to a dice game that includes two modes of play with one mode of play having up to six rounds.

### BACKGROUND

Dice games have been around for thousands of years and the current list of games that include a die as a component of the game is extensive. Dice games, in general, include any game that uses or incorporates a die as a component. A traditional die is a rounded cube with each of the six faces showing a different number or number of dots (called “pips”), typically from 1 to 6. Die are typically used to produce a random effect because any one of the six faces is just as likely to land in the upright position, thereby presenting a different number each time. How the upright number is then used in the game can vary significantly, from allowing a player to move another piece representative of the player on a board a certain number of moves based on the upright numbers on the die or dice to determining whether the player has won or lost money when the die are used for gambling.

Physical dice can be thrown singularly or in groups from a player's hand or using some form of container onto a flat surface where the dice can bounce around and eventually land with one side facing up. The thrown motion of dice can also be generated by a computer using a hardware random number generator.

### BRIEF DESCRIPTION OF THE DRAWINGS

Non-limiting and non-exhaustive examples will be described with reference to the following figures, wherein like reference numerals refer to like parts throughout the various figures.

FIG. 1 is a block diagram of a computing device in accordance with an embodiment.

FIG. 2 is a user interface illustrating an embodiment of a game table or screen.

FIG. 3 is an illustration of an embodiment where the dice game as an application on a mobile device.

FIG. 4 is an illustration of an embodiment of a welcome screen.

FIG. 5 is an illustration of an embodiment of a log-in screen.

FIGS. 6A and 6B illustrate embodiments of a create account screen.

FIG. 7 in an illustration of an embodiment of a screen indicating a proposed user name is already in use.

FIG. 8 is an illustration of an embodiment of a connect account screen.

FIG. 9 is an illustration of an embodiment for logging out of the connect account screen.

FIGS. 10A and 10B illustrate embodiments of screens for awarding points for connecting an account.

FIGS. 11A and 11B illustrate embodiments of screens for encouraging a player to connect an account.

FIG. 12 is an illustration of an embodiment of a my achievements screen.

FIGS. 13A and 13B illustrate embodiments for awarding points to a player.

FIGS. 14A and 14B illustrate embodiments for indicating a player has achieved different things.

FIG. 15 is an illustration of an embodiment of a leaderboard.

FIG. 16 is an illustration of an embodiment of a log in award.

FIG. 17 is an illustration of an embodiment of a base game screen or table.

FIG. 18 is an illustration of an embodiment of creating a bet.

FIG. 19 is an illustration of an embodiment of placing a bet in pass mode.

FIGS. 20A and 20B illustrate embodiments of the start of pass mode and rolling a match number.

FIGS. 21A and 21B illustrate embodiments of the match number and the start of the player's roll.

FIGS. 22A and 22B illustrate embodiments of a player's roll of dice in pass mode.

FIGS. 23A and 23B illustrate embodiments of the end of pass mode when a player lose and the start of the next play or pass mode.

FIGS. 24A and 24B illustrate embodiments of a player winning in pass mode.

FIGS. 25A and 25B illustrate embodiments of the end of pass mode when a player wins and the start of the next play or pass mode.

FIG. 26 is an illustration of an embodiment of placing a bet in play mode.

FIGS. 27A and 27B illustrate embodiments of the start of play mode and rolling a match number.

FIGS. 28A and 28B illustrate embodiments of the match number and the start of the player's roll.

FIGS. 29A and 29B illustrate embodiments of a losing player's roll of the dice in the first round of play mode.

FIGS. 30A and 30B illustrate embodiments of the end of play mode when a player loses in the first round and the start of the next play or pass mode.

FIGS. 31A and 31B illustrate embodiments of a winning player's roll of the dice in the first round of play mode.

FIG. 32 is an illustration of an embodiment of the end of play mode when a player wins in the first round.

FIGS. 33A and 33B illustrate embodiments of a winning player's roll of the dice in the second round of play mode.

FIGS. 34A and 34B illustrate embodiments of a winning player's roll of the dice in the third round of play mode.

FIGS. 35A and 35B illustrate embodiments of a winning player's roll of the dice in the fourth round of play mode.

FIGS. 36A and 36B illustrate embodiments of a winning player's roll of the dice in the fifth round of play mode.

FIGS. 37A and 37B illustrate embodiments of a losing player's roll of the dice in the sixth round of play mode and the award of points won in play mode at the conclusion of play mode.

FIGS. 38A and 38B illustrate embodiments of the end of play mode when a player loses in the sixth round and the start of the next play or pass mode.

FIG. 39 is an illustration of an embodiment of side bets in play mode.

FIGS. 40A, 40B and 40C illustrate embodiment of information boxes used for indicating winnings and rankings.

FIGS. 41A and 41B illustrate embodiment of information boxes used for advertising.

### DETAILED DESCRIPTION OF ILLUSTRATIVE EMBODIMENTS

The dice game includes two modes of play. During a first round of play, a player must decide to play the dice game in either the first mode or the second mode of play and then roll a set of dice and hope to either not match or match, respectively, a die previously rolled by the dealer, i.e., the match number. If a player chooses to the first mode of play and does not match any die to the dealer's die, the player wins, but if any of the player's dice match the dealer's die the player loses. If the player chooses the second mode of play, the player is hoping to match dice to the dealer's die. If there is no match, the player loses, but if there is a match, the player has the option of continuing to play, but with one less die to roll in the next round. Play continues in the second mode of play until the player completes a total of six rounds, loses, or discontinues play.

The dice game disclosed herein may be played as a physical game or as an electronic game. As a physical game, it may be played within the confines of a casino environment where a physical table is dedicated to the dice game and a surface of the table is decorated in a particular way with various indicia so as to make the game conducive, such as a gaming table. The game may also be played in other environments using a cardboard board, a plastic sheet, a material sheet, or some other flat surface that has been decorated in a particular way with various indicia so as to make the game conducive. Throughout the remainder of this description, the dice game will be described in the context of an electronic game that may be played on any type of computerized system, but the same description that applies to the computerized electronic game likewise applies to any physical embodiment of the game that does not use a computerized system or that is a combination of computerize and non-computerized components.

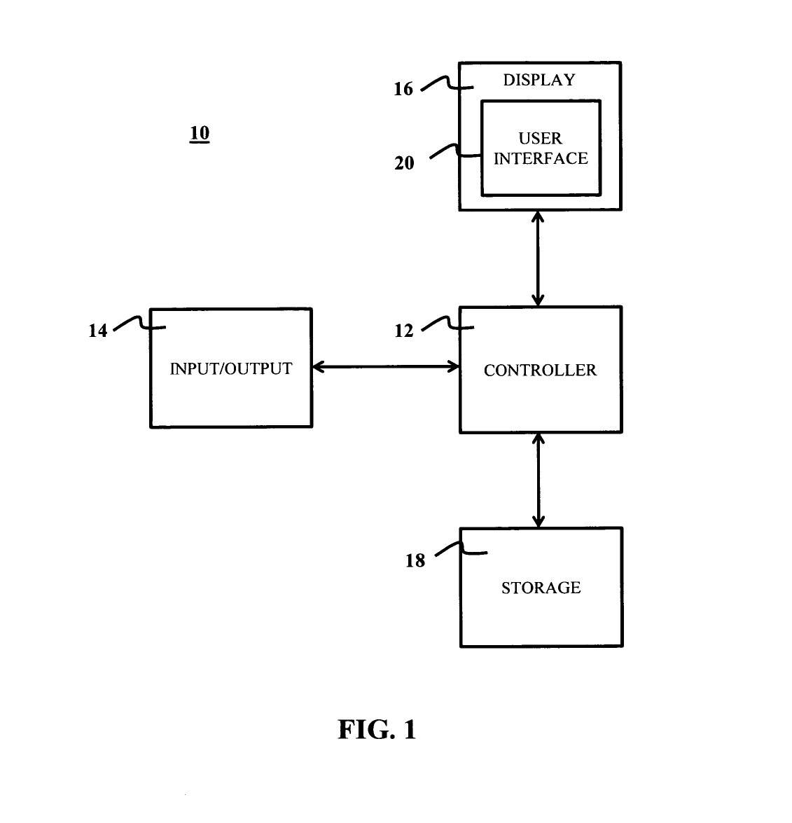

FIG. 1 illustrates a block diagram of a computer system 10 that may be used to operate the dice game described herein. The computer system may be part of a personal computer or tablet computing device, an electronic gaming system, such as a slot machine type of device, a table or other physical structure including electronic components, a mobile device, or other wireless type of device, etc. The computer system 10, in its simplest terms, may be comprised of at least a controller or processor 12, an input/output system 14, a display 18, and non-transitory storage medium 18. In place of or in addition to the input/output system 14, the display may include a user interface 20 that allows the user to interact with the display to input information, such as through use of a cursor, point device, or an interactive display surface. The input/output 14 and/or user interface 20 may include a microphone, a keypad, a touch screen, an electrical connection, an optical input, or any other suitable means for coupling the input/output 14 or the user interface 20 to a controller or processor 12 of the computer system. A user interface can also include a physical table or other surface with indicia applicable to playing the game and upon which the game can be played, dice can be rolled, bets can be placed, etc., through player interaction.

The non-transitory storage medium 18 may store computer readable software code or other machine readable instructions that may be read from storage medium 18 by controller 12 and may be used to perform numerous different tasks, such as operating the computer system 10, to operating specific applications being used by the computer system 10, such as an application that implements the dice game described herein. The storage medium 18 may also store data generated during the dice game that is applicable to one or more players, including information about a player, points or money won by the players, the player's rank among other players, etc.

The non-transitory computer-readable storage media comprises all computer-readable media, with the sole exception being a transitory, propagating signal. The storage medium 18 could be local to the controller 12 or could be remotely located to the controller 12, such as in a client-server type of arrangement. Likewise, the display 16 and input/output 14 and/or user interface 20 may be local to a user, but the controller 12 and storage medium 18 are located remotely. Further, other arrangements are possible, where there are multiple controllers 12, multiple storage mediums 18, multiple displays 16, etc., with some operations for implementing the dice game being performed by one controller while other operations are performed by another controller, where some software code is stored in one storage medium while other software code is stored in other storage mediums, and some aspects of the dice game are displayed on one display while other aspects of the dice game are displayed on other displays. Many other variations are possible and incorporated herein.

As used herein, the term “mobile device” refers to a device that may from time to time have a position that changes. Such changes in position may comprise changes to direction, distance, and/or orientation. In particular examples, a mobile device may comprise a cellular telephone, wireless communication device, user equipment, laptop computer, other personal communication system (“PCS”) device, personal digital assistant (“PDA”), personal audio device (“PAD”), portable navigational device, or other portable communication devices. A mobile device may also comprise a processor or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, the controller or processing unit 12 may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

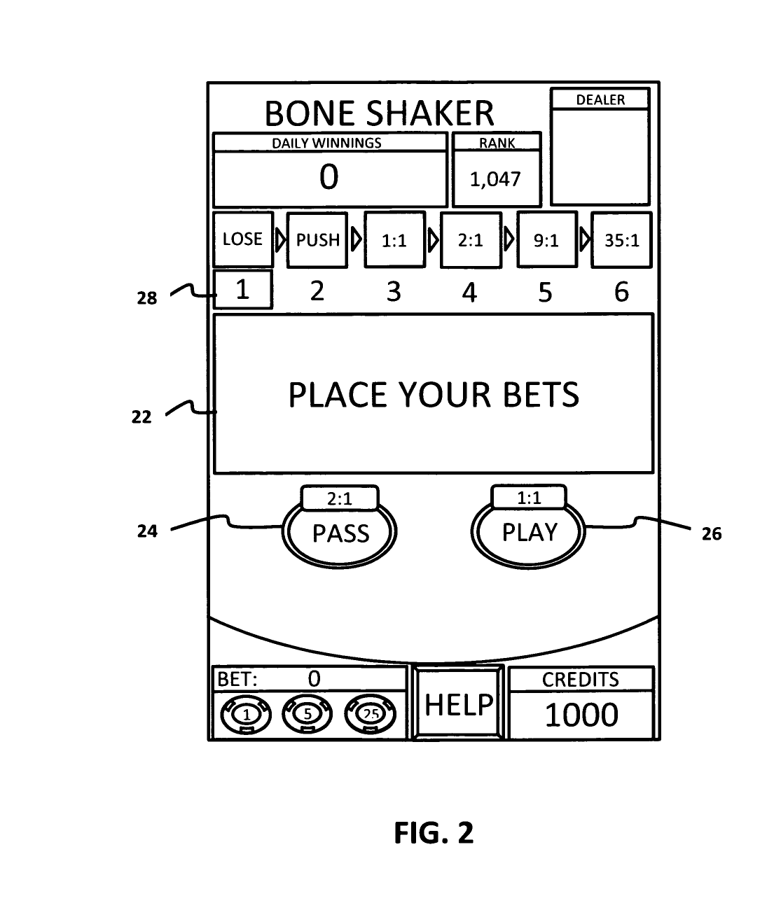

The dice game described herein is referred to as “BONE SHAKER” as the earliest dice were carved from bones and one aspect of the dice game involves shaking the dice, i.e., shaking the bones, or bones shaking. In the Bone Shaker dice game, as further illustrated in FIG. 2, users or players may be invited to place a bet 21 and determine how they want to play against the dealer. At least two options include “pass” 24 or “play” 26. Each player may also have the option of placing a side bet, as further described below.

After a bet has been place on either pass 24 or play 26, and any side bet, the dealer rolls a single die, which is then indicated on the display. As illustrated in FIG. 2, the dealer has rolled a “1” so the “1” dealer die 22 is highlighted. Once the dealer's die 22 is indicated, the player may then roll 6 dice to see if any of the player's dice match the dealer's die. If the player selected pass 24, then only a single round may be played. If the player selected play 26, and the player rolled at least one die that matches the dealer's die, then the game may continue to the next round. There may be a total of six rounds of play if the player can make it through each round by matching one of the player's die to the dealer's die. However, the first round starts with 6 dice and each subsequent round may include one less die for the player, such that the player may only be rolling one die on the last round. As the probability of winning a round, i.e., rolling at least one matching die, goes down, the payout may increase. Hence, the payout may increase with each round. Although many different betting options may be available, in an embodiment, the maximum bet for the entire 6 rounds may be 500 points, where points could have no monetary value or a monetary value.

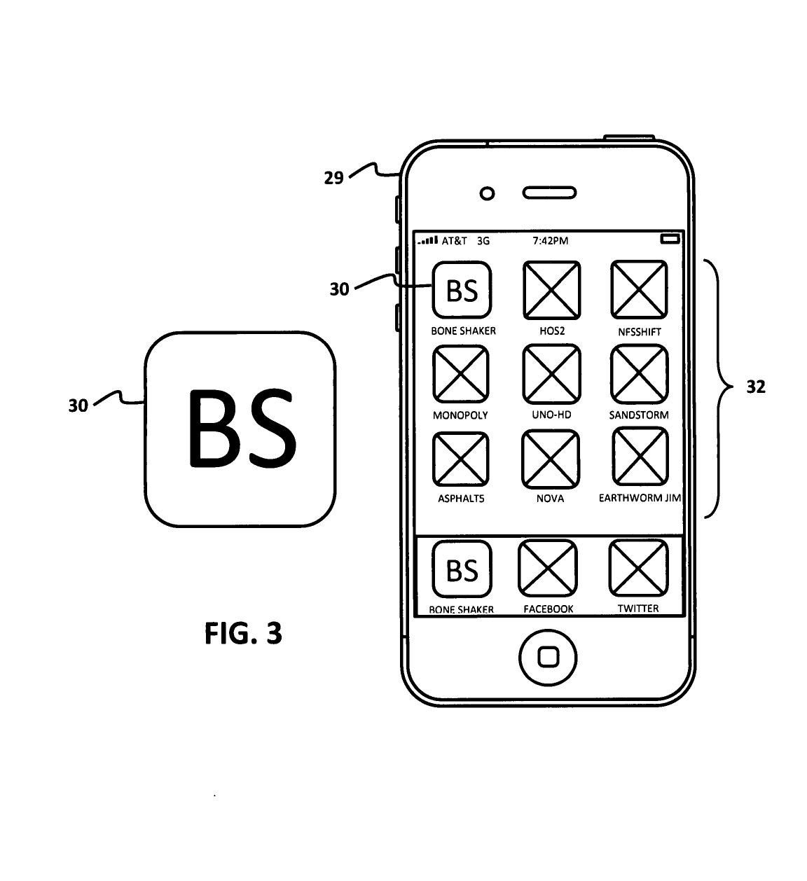

In an embodiment, the dice game may be stored as a software application on a mobile device 29 and played on that mobile device 29. As illustrated in FIG. 3, the dice game may be purchased or downloaded from a mobile device application store, such as ITUNES or ISTORE. Once the dice game application is downloaded to the mobile device 29, an icon 30 may appear within the game section 32 on the players mobile device.

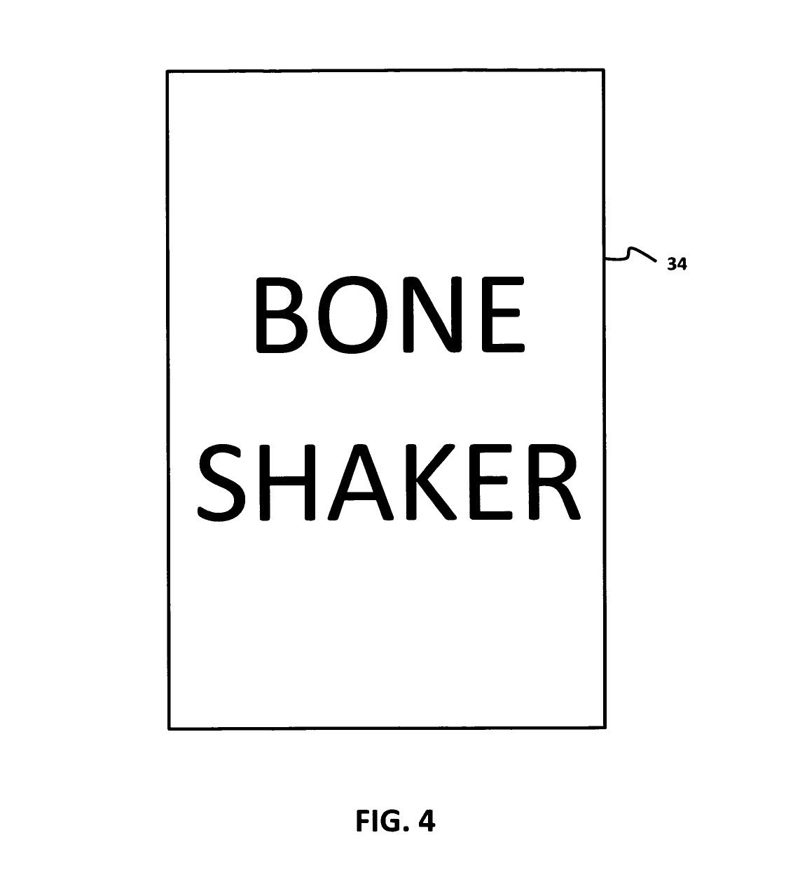

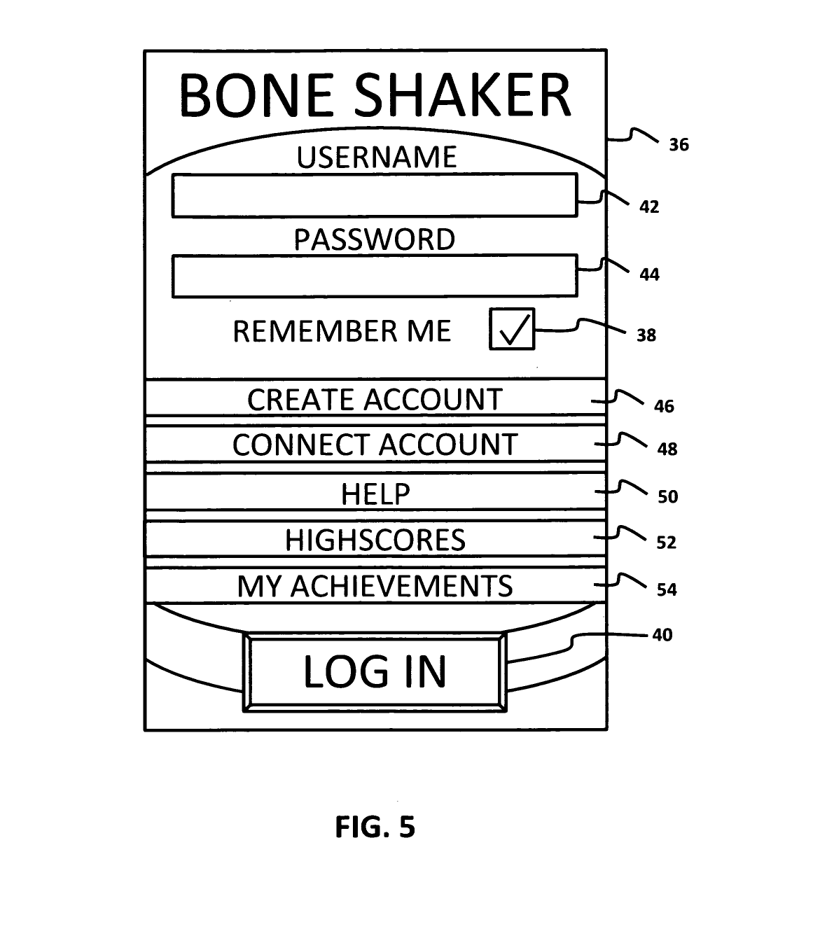

When the dice game application is selected, the application may launch and a splash screen 34 of FIG. 4 may be displayed, indicating that the dice game application has started. The splash screen can include any type of display desired and can be displayed as long as necessary or desired. In an embodiment, the splash screen 34 may be displayed for 2-3 seconds before the splash screen is replaced with the log in screen 36 of FIG. 5. Regardless of whether a player has previously registered or is not registered, the player may have to log in through log in screen 36 in order to play the dice game and get access to any credits they may have available to them at that time.

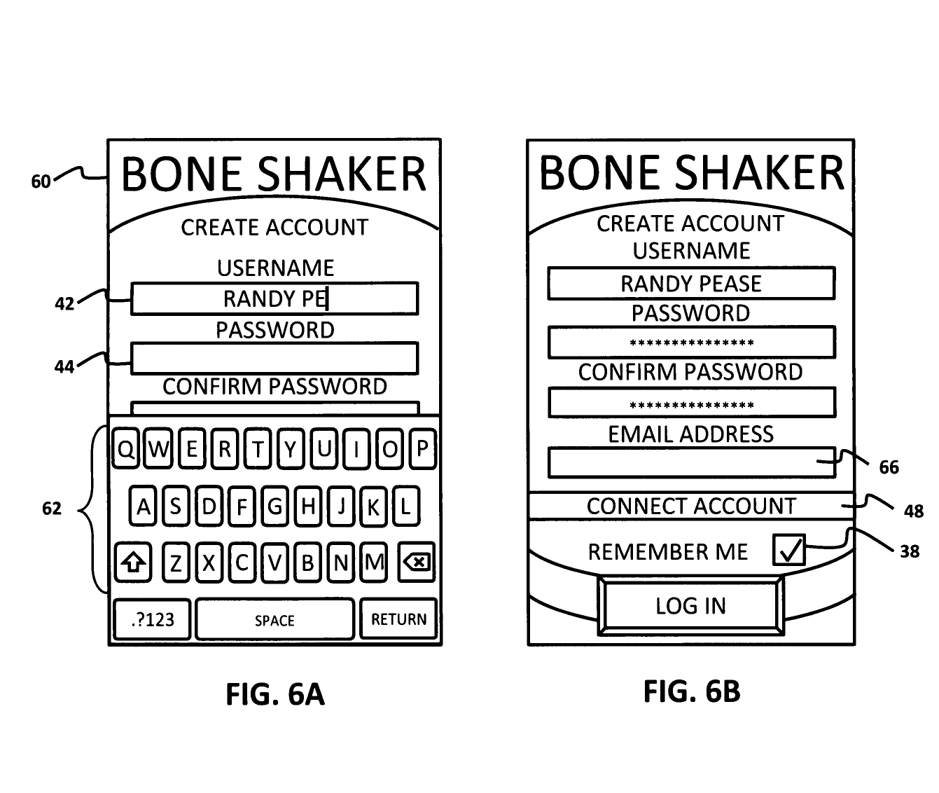

If a player is a returning player, and has had the application previously remember them by selecting the remember me box 38, the player may only need to select the log in button 40 to get past the log in screen 36. If the returning player did not select the remember me box 38 during a prior log in, then the player may have to enter a username 42 and a password 44. If the user is a new user, then the user may have to select the create account button 46 in order to access a create account screen as illustrated in FIG. 6A below. As will also be further discussed below, if the player has previously created an account, the player may select the connect account button 48 to connect or link their account to other applications or services, such as FACEBOOK or TWITTER. The player may only connect their account to the other applications or services once the account has been created. The player may also select the help button 50 to access numerous help screens that help to explain how to play the dice game. Selecting the highscores button 52 may cause the player to be presented with a leaderboard as well as daily, weekly and monthly high scores. Selecting the my achievements button 54 may cause the player to be presented with a list of things they have or can accomplish through past or continued play of the dice game.

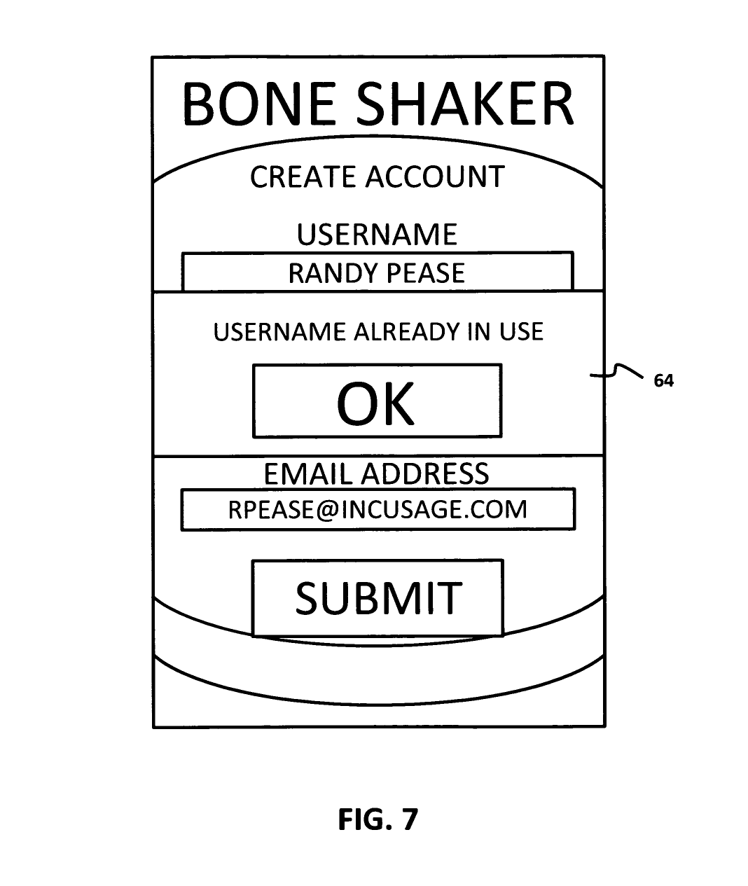

When a player selects the create account button 46, the player may be presented with the create account screen 60 of FIG. 6A. Through the create account screen 60 the player may be prompted to enter a username 42 and password 44. When an area within the username box 42 is selected, the dice game application may automatically present the user with a keyboard interface 62 so the user can type in the username in the box. As illustrated in FIG. 7, if the username is already in use, the player may be prompted to enter a new username and to continue doing so until the player has selected a unique user name.

Once the username has been accepted, selecting an area within the password box 44 may likewise cause the dice game application to present the user with the keyboard interface 62 so the password can be entered. Once the password has been created, the player may be asked to re-enter the password to confirm that password. Confirmation is performed to verify that the same password was entered both times, thereby providing some assurance that the player did not make a mistake the first time and may remember the password. If the passwords do not match, the user may be prompted to reenter the passwords until both passwords match.

As illustrated in FIG. 6B, once the password has been confirmed, the player may then be prompted to enter an email address 66 so the player can be contacted by the operator of the dice game application. Again, the player will have the option of connecting the account to other applications or services through the connect account button 48 and to have the username and password remembered with remember me box 38. In an embodiment, only the username may be remembered so the player has to enter a password each time.

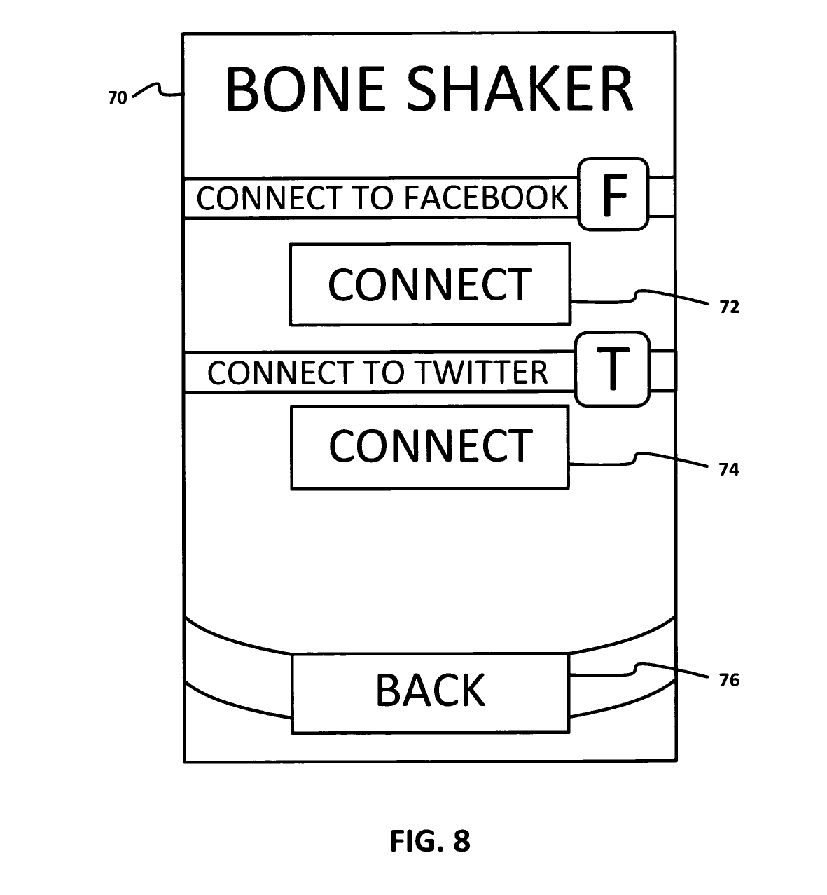

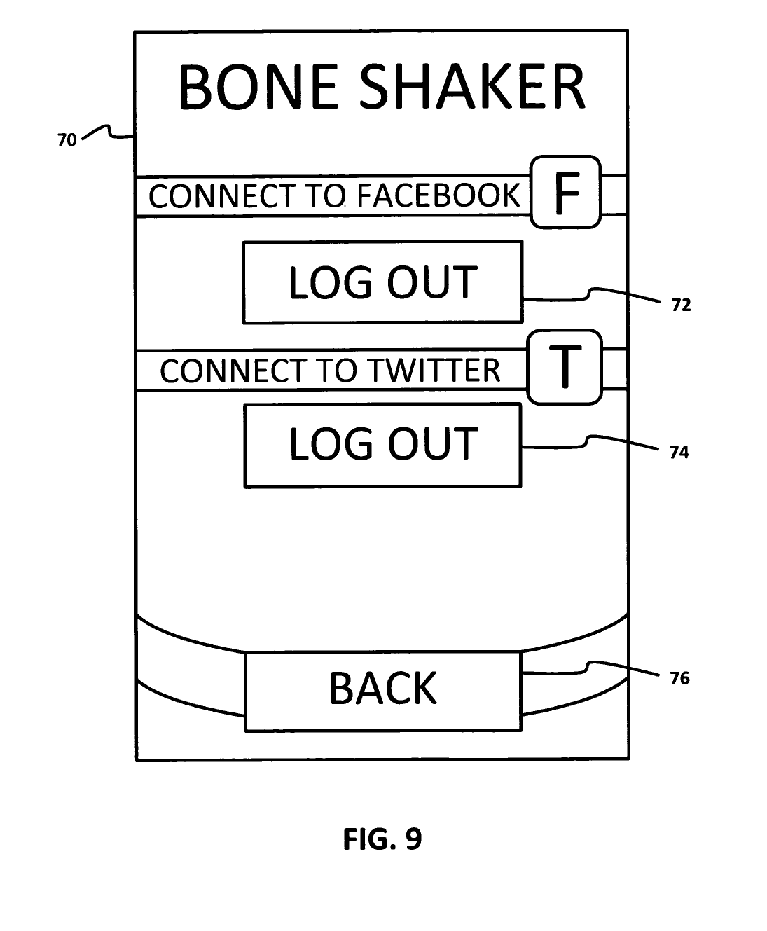

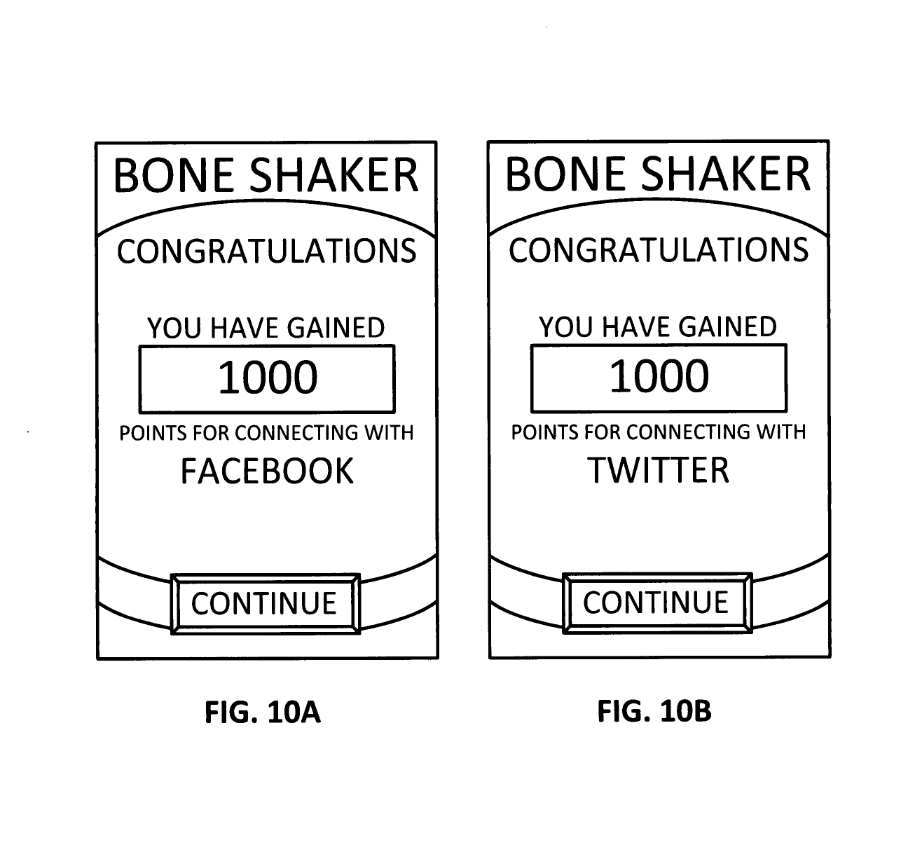

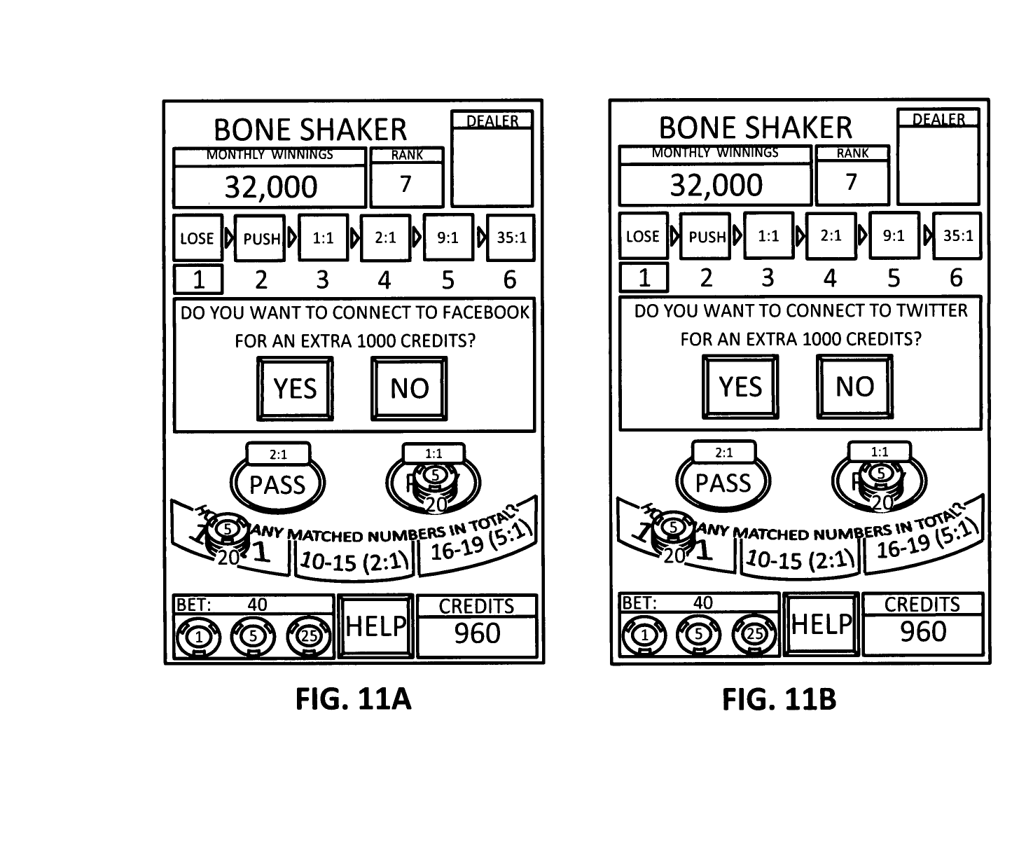

Once the account has been created, if the player selects the connect account button 48, the player may be presented with the connect account screen 70 of FIG. 8. Only two examples are illustrated in FIG. 8, but the number of applications or services to which the account may be connected to or linked to is not limited so any other application or service could be displayed in place of or in addition to the two examples provided. If the player wants to connect to FACEBOOK, the user may select the FACEBOOK connect button 72 and the player may be redirected to a log in page for FACEBOOK and asked if the player wanted to share their information from the dice game application over this platform with their friends on FACEBOOK. Likewise, selecting the TWITTER connect button 74 may take the user to the TWITTER log in page for the same purpose. After the player agrees to such terms, and perhaps other terms and conditions, the FACEBOOK connect button 72 and/or TWITTER connect button 74 turn into log out buttons, as illustrated in FIG. 9. Pressing the back button 76 may return the player back to the log in screen 36. As a reward for connecting with an application or service, the player may be awarded a number of points, such as illustrated in FIGS. 10A and 10B, where the player is awarded 1000 points for connecting with either FACEBOOK to TWITTER. Any amount of other points could also be awarded, or no points at all. In addition, as illustrated in FIGS. 11A and 11B, during game play, if a player has not previously connected to an account, the player may be prompted to connect to an account for some amount of extra credits. Such a prompt may be generated periodically, such as every five games played, or based on some other factor, until such time that the player connects to an account or the prompt function times out or is repeated some number of times without being selected by a player.

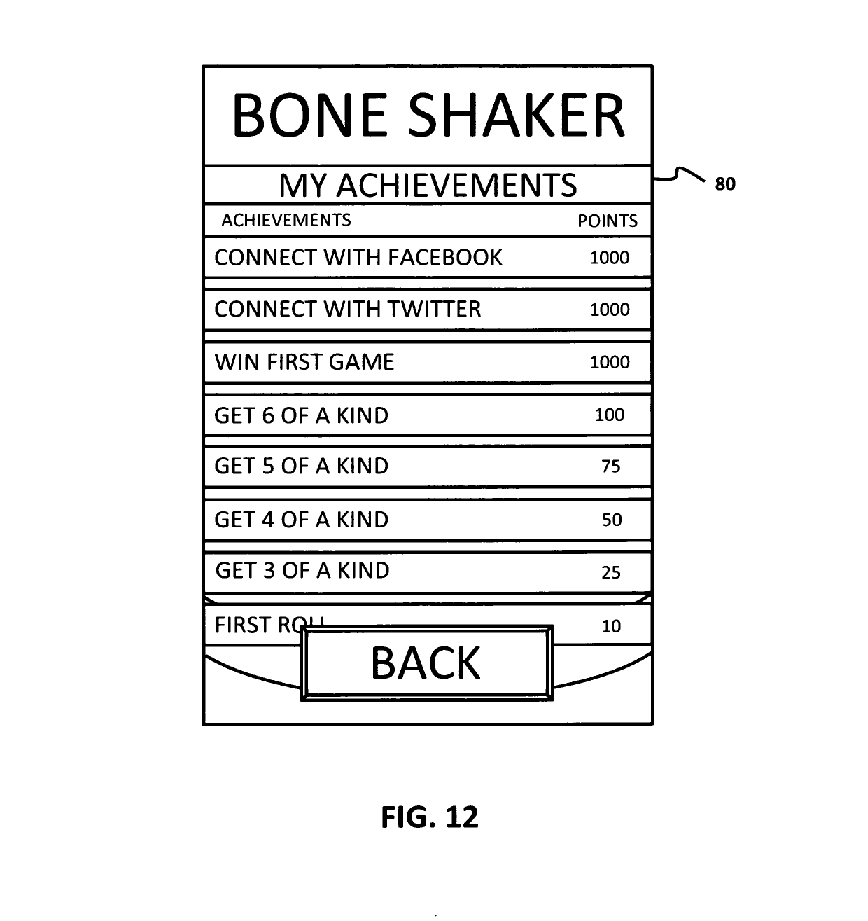

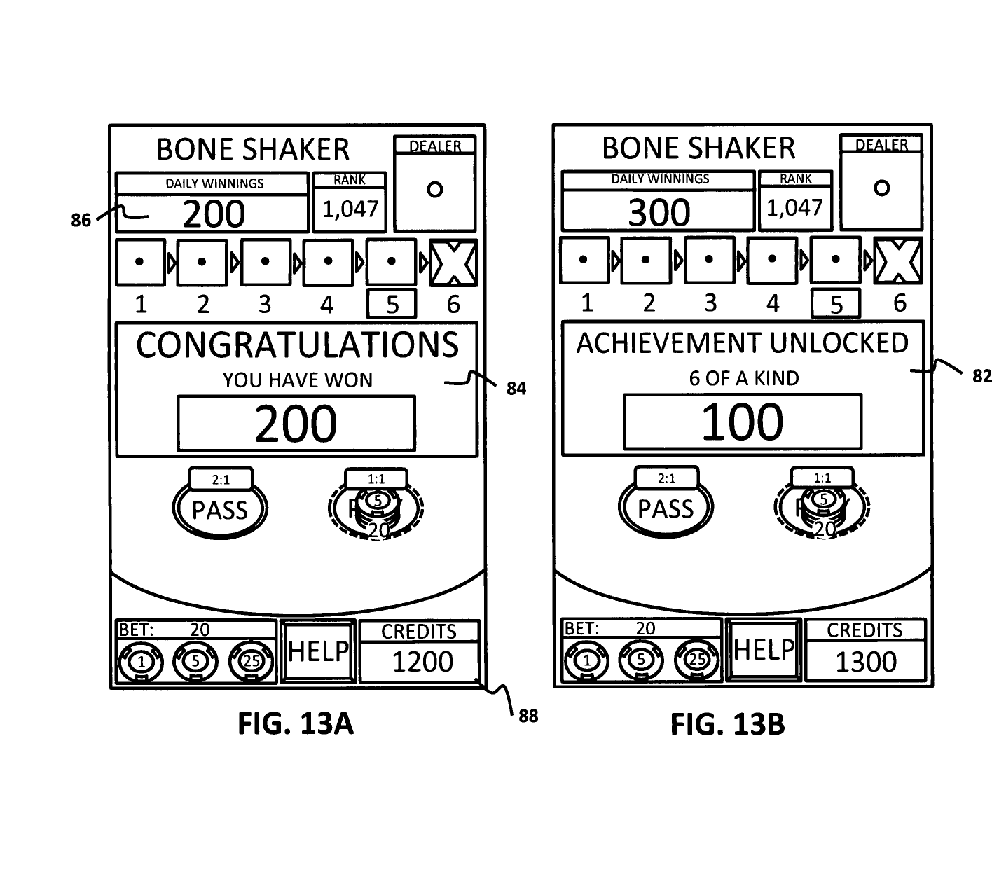

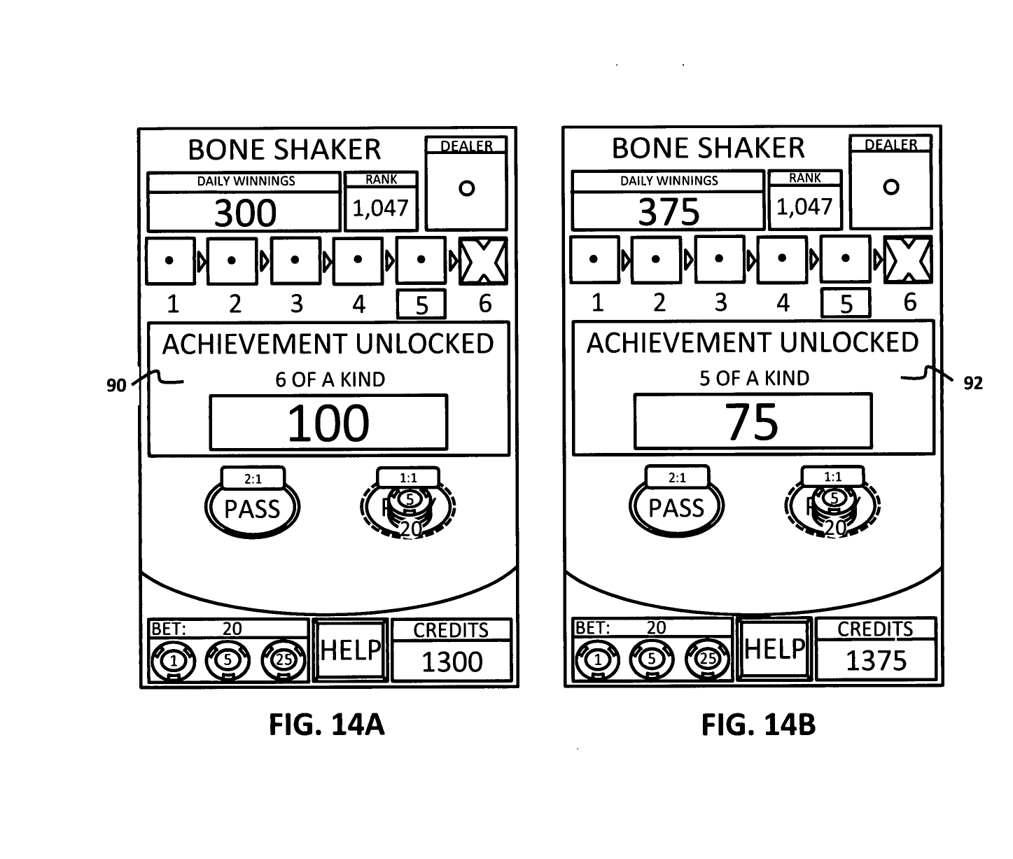

As previously noted, when the player selects the my achievements button 54, the player may be presented with a list of achievements 80 relative to the dice game, as illustrated in FIG. 12. If no achievements have been accomplished, the list may include a list of things that could be done by the player to fulfill one or more achievements, such as connecting with an account, winning a first game, getting 6 of a kind, 5 of a kind, 4 of a kind, 3 of a kind, completing a first roll, etc. In addition to listing the achievements, the player may see a number of points associated with each achievement, as a further incentive. In an embodiment, all of the achievements may be grayed out and as a player accomplishes each one, the achievement is highlighted instead of being grayed out. In an embodiment, the list may not be interactive and the player may only review the list. In an embodiment, the list may be interactive and other functionality may be associated with a selected achievement when the achievement is selected by the player. When a player accomplishes an achievement during the game, the player may be presented with a achievement prompt 82, such as illustrated in FIG. 13B, at the end of the game, whether they win or lose. If the player won as well, then the player may be first presented with the congratulations prompt 84 of FIG. 13A first, then followed by the achievement prompt 82. If more than one achievement is accomplished during the course of one game, all of the achievement prompts may be displayed at the end of the game, in order from lowest to highest, highest to lowest, in the order accomplished, or some other order. For example, as illustrated in FIGS. 14A and 14B, achievement prompt 90 for 100 points is displayed before achievement prompt 92 for 75 points because the prompts are displayed in the order of highest award to lowest award. Each time a player wins any points, the points may be added to the dating winnings box 86 and the credit box 88.

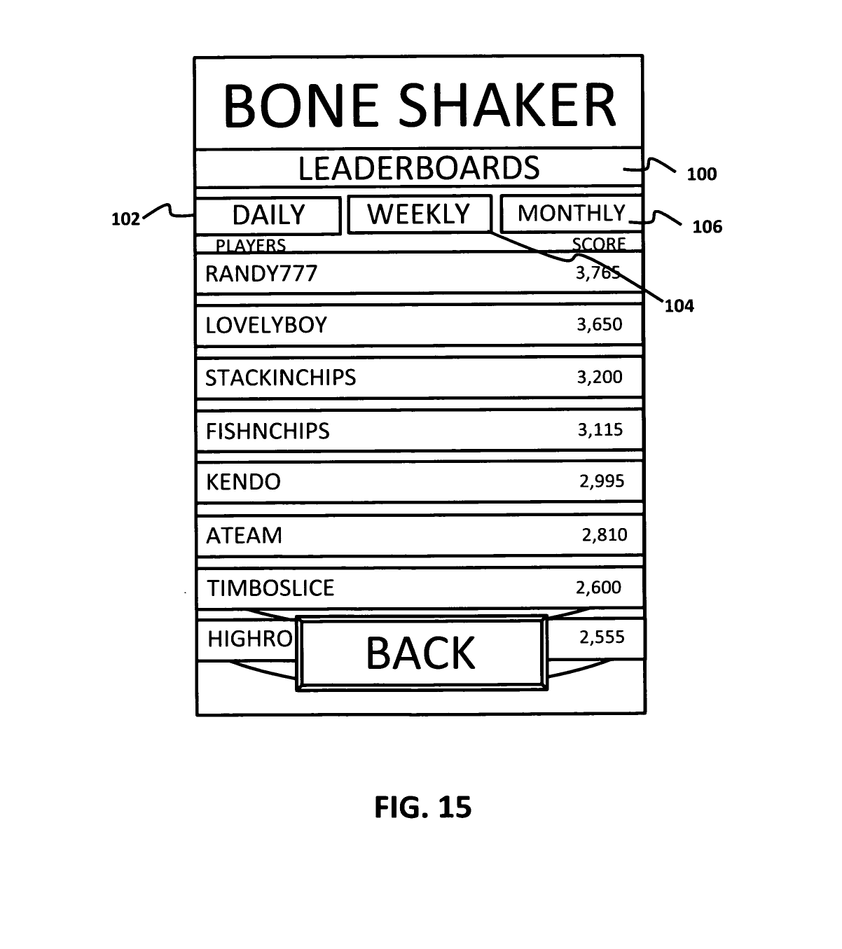

Also, as previously noted, when a player selects the highscores button 52, the player may be displayed the leaderboard screen 100, as illustrated in FIG. 15, which may include a list of other players with the daily, weekly or monthly highest scores. Selecting the daily button 102 may cause a list of players with the highest points that day to be listed, along with their point totals, while selecting the weekly button 104 may cause a list of players with the highest points that week to be listed, and selecting the monthly button 106 may cause a list of players with the highest points that month to be listed. A day may constitute a 24 hour period based on the user's time zone, or some other time zone. A week may be based on a calendar week or the prior seven days. A month may be based on the calendar month or a prior 30 day period. The number of players listed may be limited to a top 10 or 20, or could include a list of all players, by username, that could be scrolled.

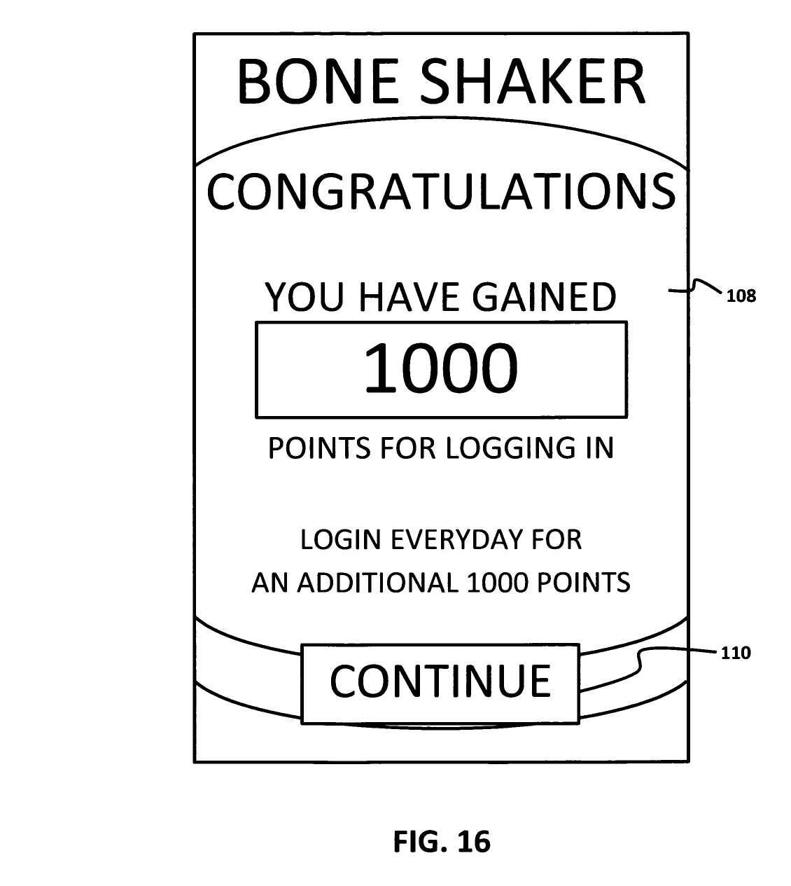

Players may also be awarded credits for playing every day. In addition to being awarded points for creating an account, a player may be encouraged to continue playing by continuing to receive a certain number of points, say 1000 points, every day, once a day, when the player logs in and plays at least one game. The amount of points could vary and the basis for the credits could vary as well. For example, in an embodiment, a player is awarded points for just logging in, regardless of whether any games are played, whereas in a different embodiment, a certain number of games must be played before the player is presented with the daily credit prompt 108 of FIG. 16.

An objective of the dice game is for a player to determine if they want to pass or play against the dealer's single dice roll. If a player selects to pass, the player only has one round of play. If the player selects to play, the player has the potential to have 6 rounds of play. But the choice is not without consequence. To progress thru the rounds, the player has to match at least one die per round with the dealer's roll. When playing a physical version of the game, the dealer's roll is determined by the dealer rolling a single dice, which the player's roll is determined by the player rolling between 1 and 6 dice, depending on the round of play. As previously noted, on the first roll, the player rolls 6 dice, and the total dice rolled is reduced by one for each subsequent roll, until the sixth roll, assuming the player has progressed that far, when the player only rolls one die. In each case, the rolls are random. Likewise, in an electronic version of the game, a hardware random number generator or other form of random number generator may be used to generate each roll of a dice.

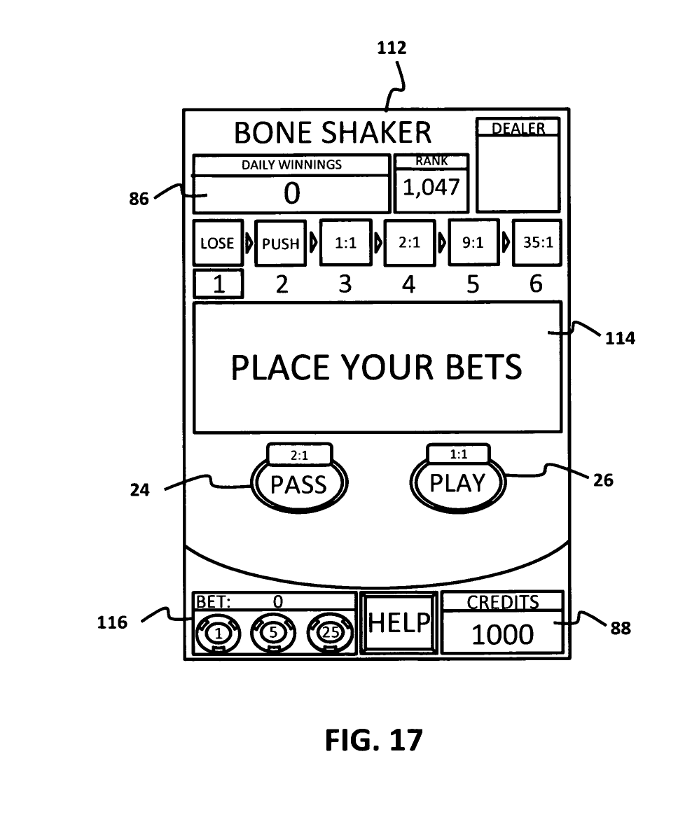

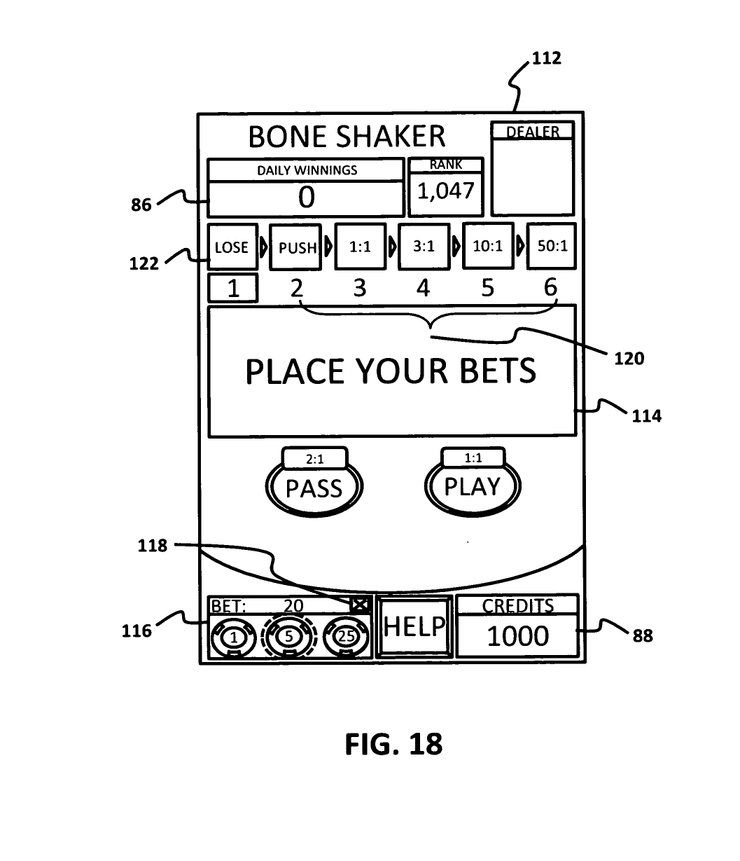

After collecting any daily credits that have been awarded, such as in FIG. 16, the player may select the continue button 110 and may thereafter be presented with the base game screen 112 illustrated in FIG. 17. The player is prompted to place a bet by prompt 114, which may remain in place until a bet amount and a bet type has been selected. To place a bet, the player may touch one the of chip images in the bet box 116. Each touch, whether done with a finger on a touch screen or using some type of pointing device, may cause the touched chip to be highlighted (represented by the dashed line around the 5 chip, for example) and for the bet amount to be increased, say from “0” as shown in FIG. 17 to a number that corresponds to the chip image touched. If the 1 chip was touched, the bet amount may change to 1, while if the 5 chip or 15 chip was touched, the bet amount may change to 5 or 25, respectively. At the same time that the bet is being increased from 0 to some higher number, the credits 88 is being reduced by a corresponding amount. Since each touch of a bet chip increases the bet, touching the 5 chip four times may result in a 20 point bet, as illustrated in FIG. 18. After a bet has been placed, an “X” or “Cancel” button 118 will appear next to the bet amount so the player can clear the bet and start over, if desired. One touch of the cancel button 118 may remove the last chip or point value added, while pressing the cancel button 118 twice will clear the bet amount back to 0. Once the bet has been made, the player may then either press pass 24 or play 26 to continue.

If the player selects pass 24, the player is betting that the player will roll 6 dice and none of the 6 dice will match the die previously rolled by the dealer. If none of the player's rolled dice match the dealer's rolled die, the player may win, but if there is a single match, the player may lose. The amount the player wins may be determined by the betting odds appearing as part of the pass 24 image. As shown in FIG. 17, the odds are 2:1, but any set of odds could be chosen. The pass 24 function may only be available for the first roll of 6 dice. Win or lose after selecting to pass 24, the player will have to replay or place another bet to play again. In an embodiment, a player could place bets on both pass 24 and play 26, with the pass mode bet effectively operating as an insurance bet on the first roll of the play mode bet.

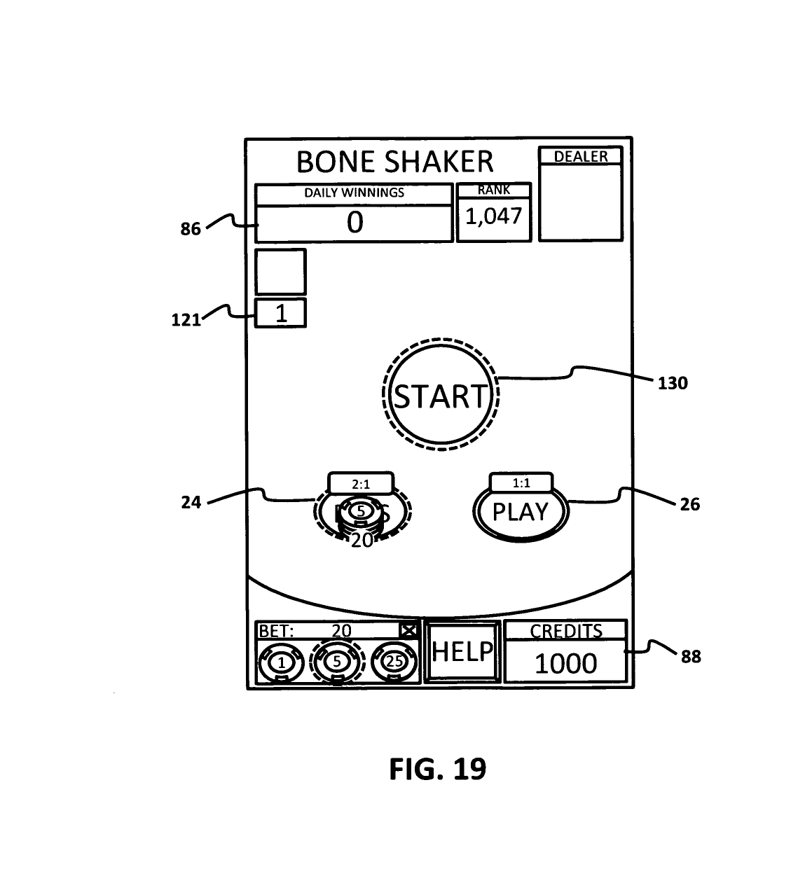

When the player selects pass 24, all of the round boxes 120, except for the first round box 121, along with the progression arrows 122, may disappear from the screen, except for the box around “LOSE”, which text may disappear, and the place your bets prompt 114 may be replaces with a start button 130, as illustrated in FIG. 19. A stack of chips 132 representing the bet amount may appear in the pass area 24, along with the bet amount underneath it. The pass area 24 may also be highlighted, represented by the dashed line around the pass area 24. Until the start button 130 is pressed, the player can change the bet or change between pass 24 or play 26. The game begins once the player has placed a bet on pass or play and selects the start button 130, at which point the bet box 116 and cancel button 118 may be disabled.

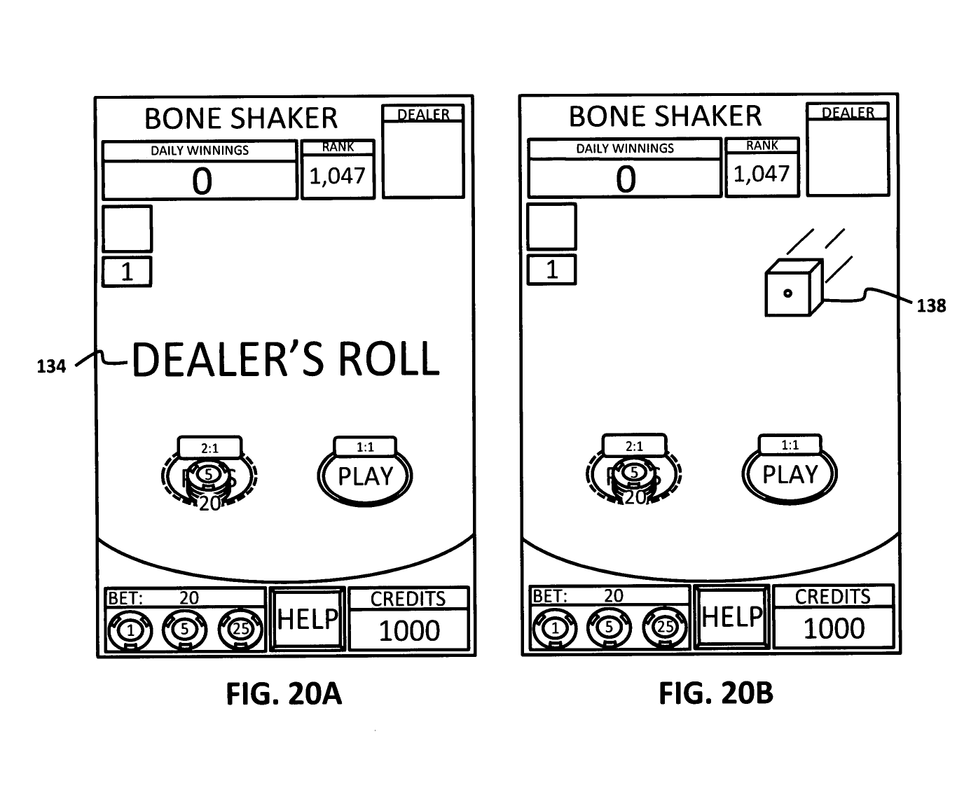

Once the start button 130 has been pressed, the start button 130 may disappear and be replaced with the text “DEALER'S ROLL” 134, as shown in FIG. 20A. The dealer's die 138 may then roll onto the screen, as illustrated by the lines behind the die shown in FIG. 20B, which starts from the upper right corner of the screen and stops rolling on a randomly generated number. Animations of the die 138 and the screen and sounds, such as music or spoken words, may accompany the dealer's roll.

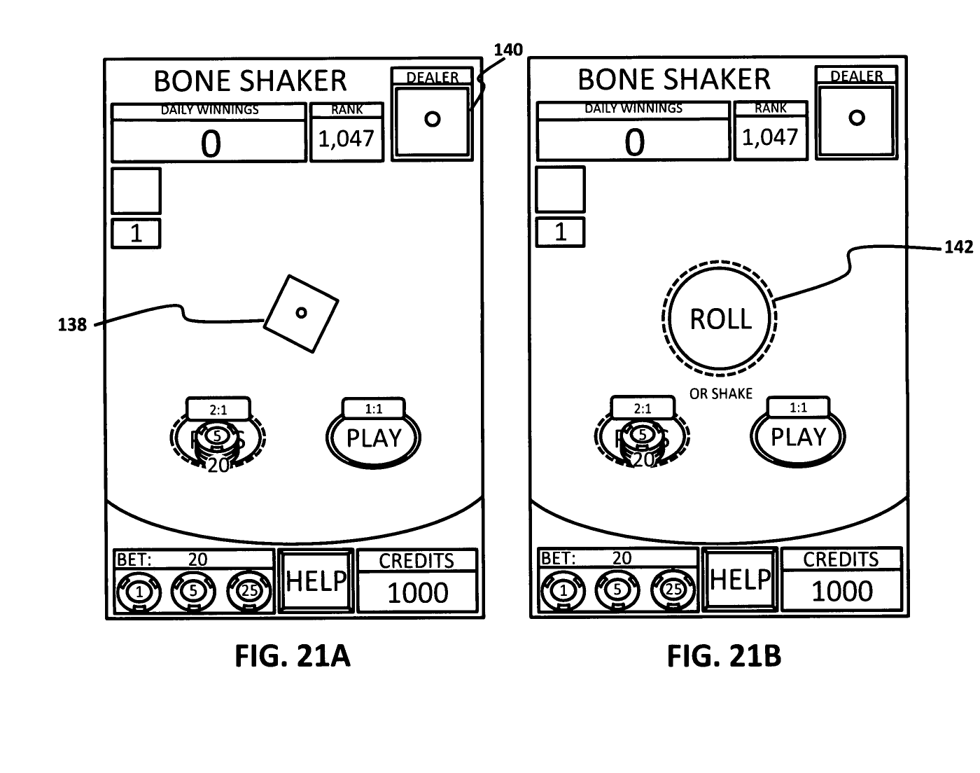

When the die stops rolling, the pips represented on the die 138 may then appear in the dealer's box 140 in the upper right corner of the screen, as shown in FIG. 21A, and the rolled die 138 may disappear. In addition, as illustrated in FIG. 21B, the highlighted roll button 142 may appear in place of the rolled die 138. Once the roll button 142 appears, it is the player's turn to roll, which may be accomplished by pressing the roll button, or if the dice game is being played on a mobile device that supports a form of motion control, the player may be able to simply shake the phone to initiate the player's roll of the dice.

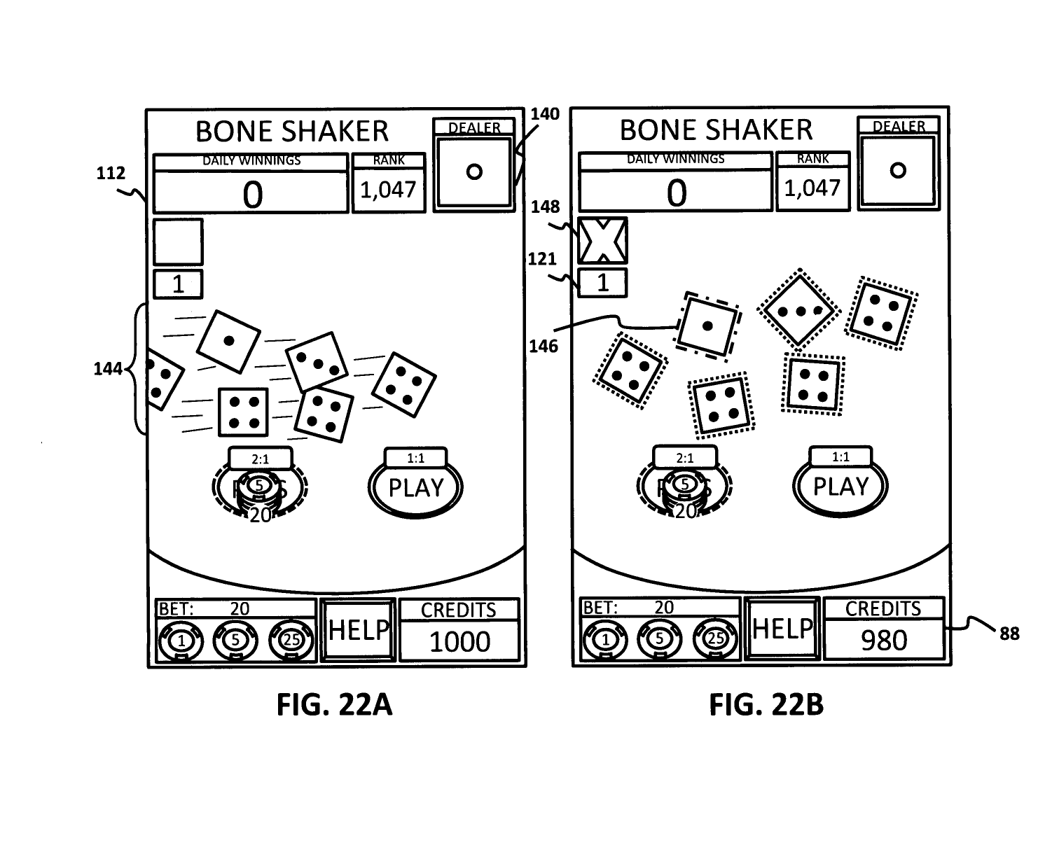

Once the player's roll has been initiate, the player's dice 144 may roll onto the screen 112 from the left side of the screen, as illustrated in FIG. 22A, and may stop in the middle of the table 146 represented on the screen 112. Once the player's dice 144 have stopped, highlights may appear around each die, as illustrated in FIG. 22B. The controller 12 of the dice game application may then check for non-matches first, one die at a time, and differently highlight the die as each match is completed. For example, the highlights when the player's dice 144 have stopped may be a neutral color or shape, but as each die is checked for a non-match, the highlight may change to indicate whether there is a match or not, for example, with a green highlight indicating no-match, or success, and a red highlight indicating a match, or failure. Remember, the player has chosen the pass 24 mode version of the game, so the objective for the player is to not match any of the player's rolled dice 144 against the dealer's rolled die 140. As illustrated in FIG. 22B, the player has lost because one of the player's rolled dice 144 is a 1, which matches the dealer's rolled die 140. The matching die 146 may be highlighted differently from the other die among the player's rolled dice 144 to indicate it is a losing die. In addition, a large “X” 148 may appear above the first round play box 121 to indicate that the first round was lost, and the amount of the bet, in this case 20 points, may be decremented from the credits 88, bringing the total to 980 from the original 1000.

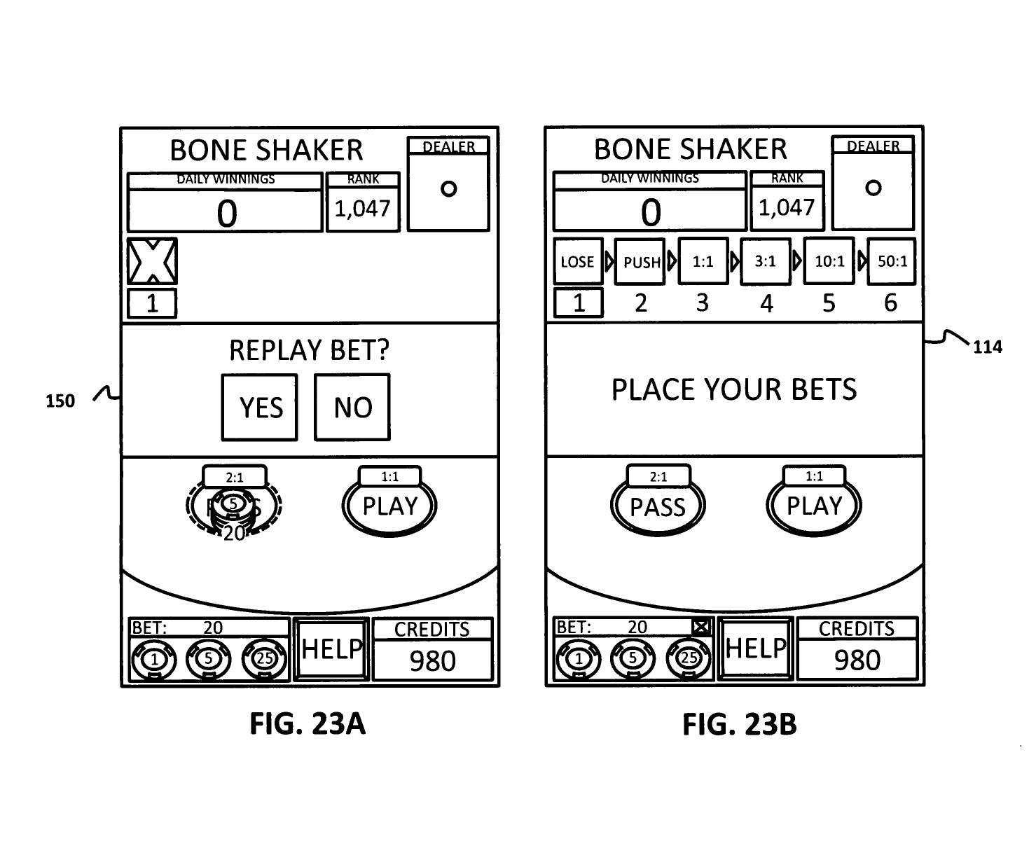

Upon completion of the pass mode of play, the player may be presented with a replay prompt 150, as shown in FIG. 23A. Selecting yes from the replay prompt 150 may cause the same bet amount to be replayed, while selecting no from the replay prompt 150 may cause the place your bet prompt 114 of FIG. 23B to be displayed again.

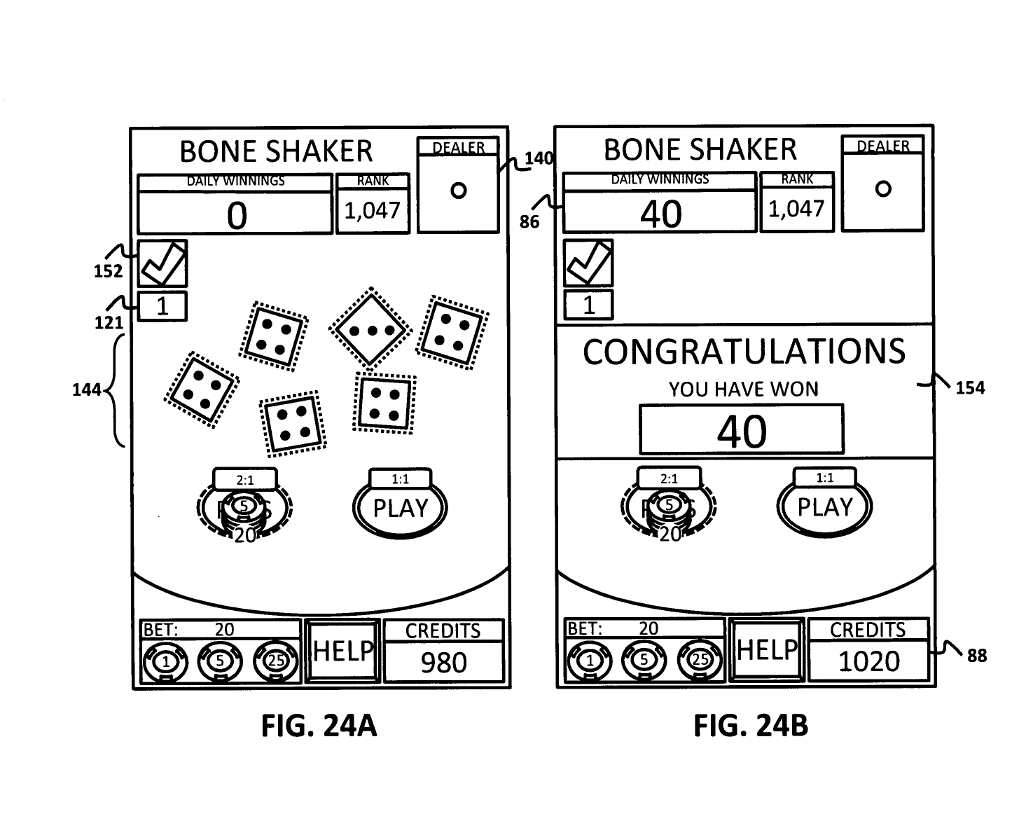

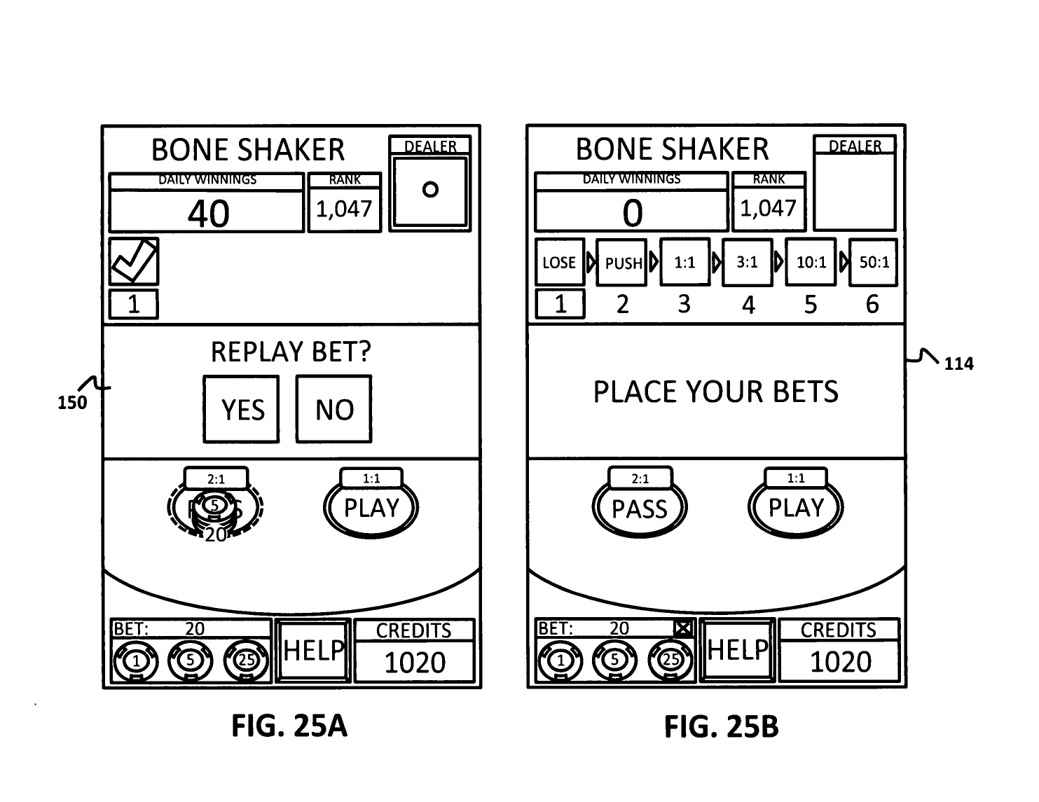

If the player had not matched any of the player's rolled dice 144 against the dealer's rolled die when playing in the pass mode of play, as illustrated in FIG. 24A, a check mark 152 may appear above the first round play box 121 to indicate that the first round was a winning round. The check mark 152 may be colored green to indicate a win, while the X 148 is colored red. Sounds and animations may also be generated to indicate a winning or losing round of play. As the betting odds were 2:1, the 20 point bet results in 40 points being won, as indicated by the congratulations screen 154 of FIG. 24B, and the credits 88 being increased by 40 points to 1020 points, and the daily winnings box being incremented to 40 points, or by 40 points is the total was already something other than 0. Upon completion of the pass mode of play, the player may be presented with a replay prompt 150 again, as shown in FIG. 25A. Selecting yes from the replay prompt 150 may cause the same bet amount to be replayed, while selecting no from the replay prompt 150 may cause the place your bet prompt 114 of FIG. 25B to be displayed again.

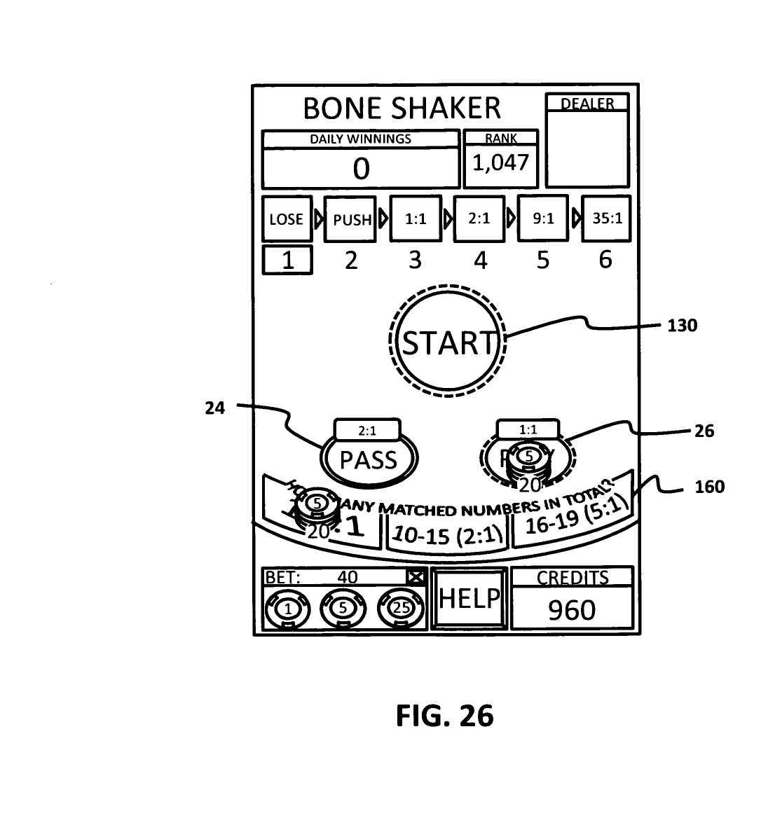

The play mode of play will now be described starting with reference to FIG. 26. When a player selects play mode 26 instead of pass mode 24, the objective of the game changes from trying not to match the dealer's die to trying to match the dealer's die in each round of play. If one of the player's die matches the dealer's die, then the player may win, collect the bet amount multiplied by the odds of the round, and advance to the next round, but if there is no match, the player may lose the round and any amount bet. The play mode may continue until the player loses a round or completes all of 6 possible rounds.

As illustrated in FIG. 26, when the play mode is selected, the play area 26 may be highlighted and the chip images and the corresponding amount of the bet may be indicated within the play area 26. In addition, the start button 130 may appear and be highlighted. Lastly, side bets 160 may be enabled. At this point, the player can change the bet, change between pass mode or play mode, or place a side bet. If the player selects pass mode, the side bets 160 are disabled. The game will begin once the start button 130 is selected.

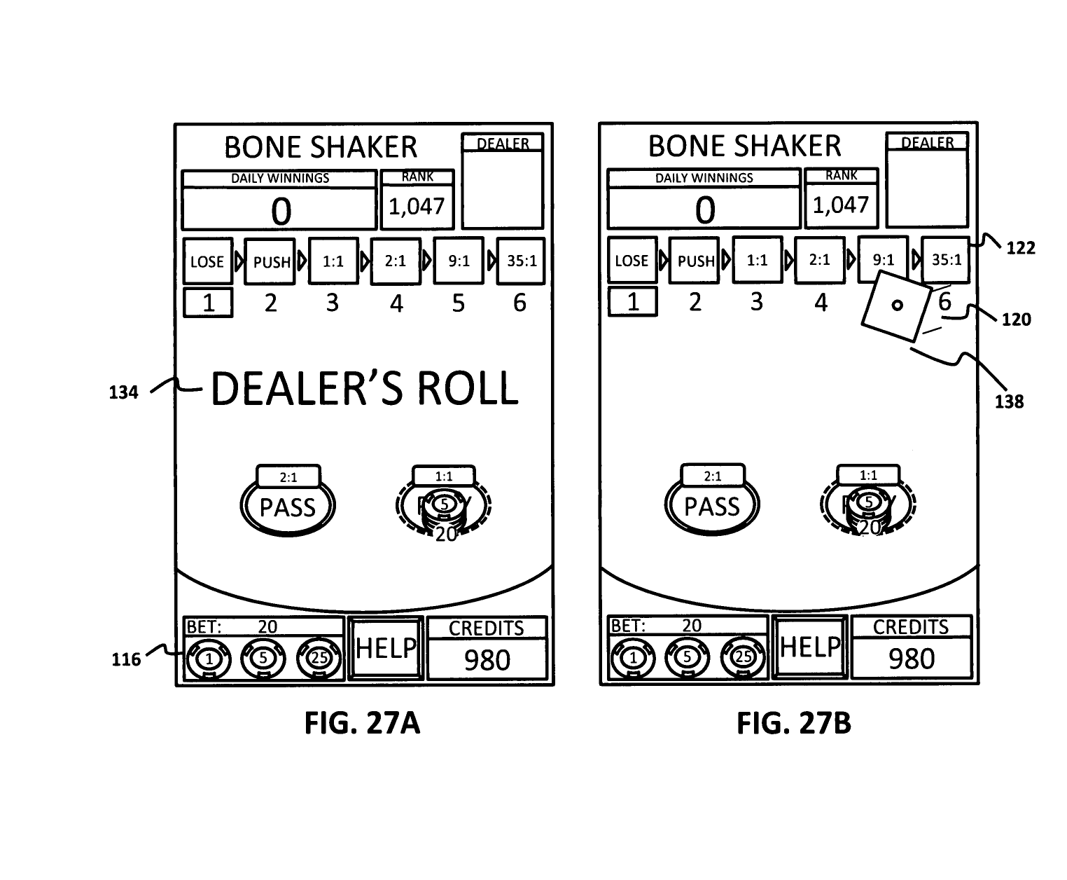

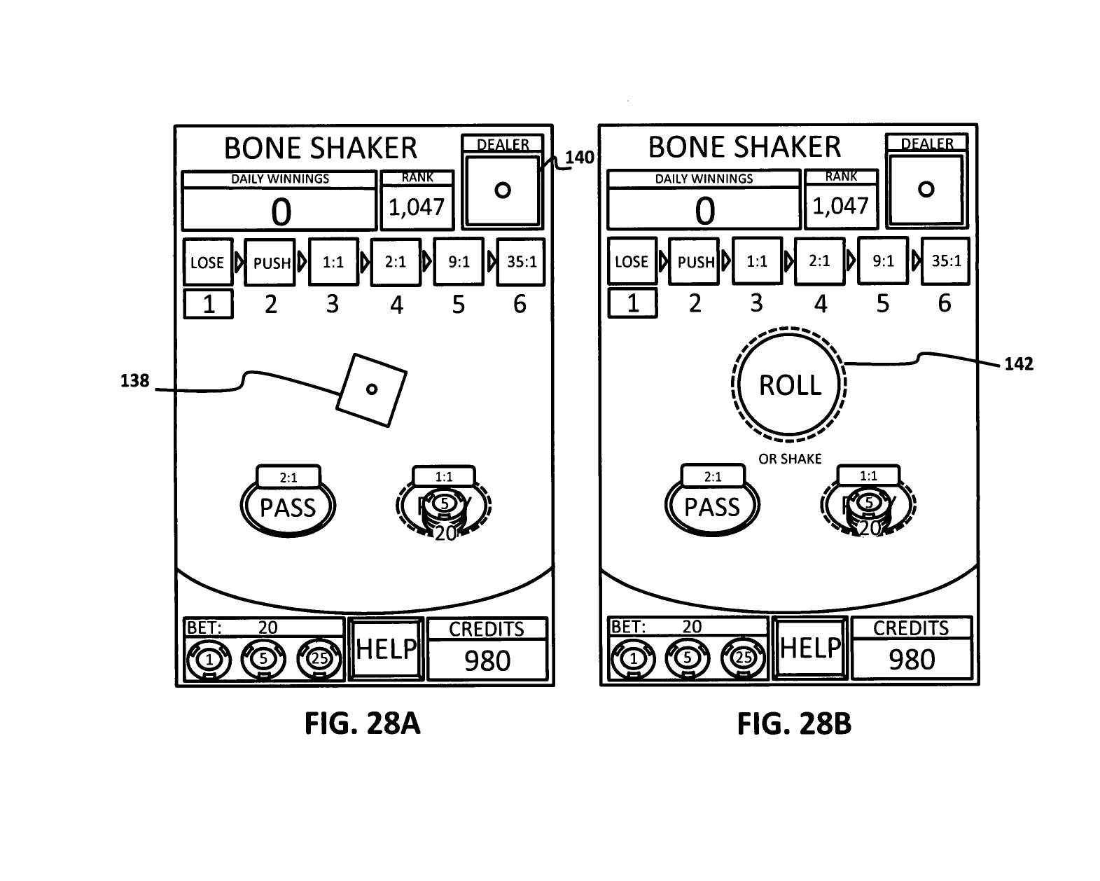

If the player presses the start button 130 while play mode is selected, the bet box 116 may be disabled, the side bets 160 may disappear, the start button 130 may be replaced by the DEALER'S ROLL text 134 for 2-3 seconds, as shown in FIG. 27A. Since the dice game is now in play mode, which includes up to 6 rounds, all of the round boxes 120 may remain, along with the odds progression arrows 122. The dealer's die 138 may then roll onto the screen or table from the upper right corner, as shown in FIG. 27B, and stop rolling on a randomly generated number, which is again shown as 1 pips, which may be shown as the dealer's rolled die 140, as shown in FIG. 28A. Animations and sounds may accompany the dealer's roll. Once the dealer's die 138 has stopped rolling and the dealer's rolled die 140 is displayed, the dealer's die 138 may be replaced with the roll button 142, as shown in FIG. 28B, which may be activated by touching the button or shaking the mobile device operating the dice game application, as previously described.

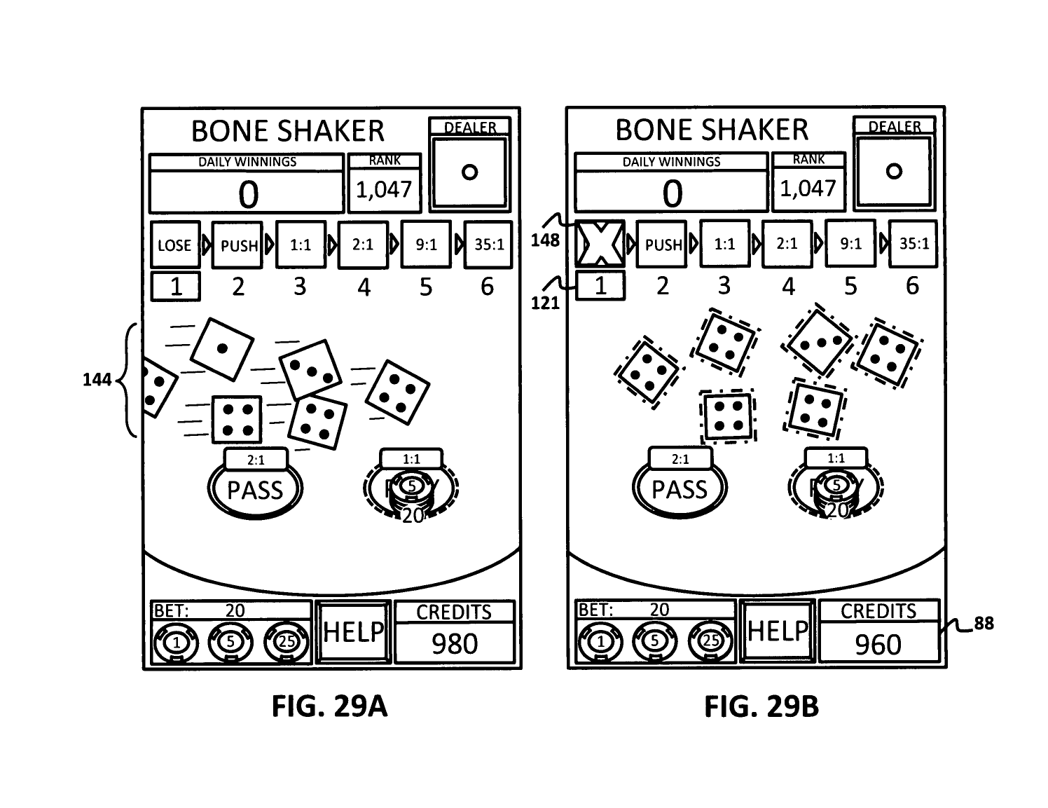

Activation of the player's roll may cause the player's rolled dice 144 to roll onto the screen from the left side of the screen, as shown in FIG. 29A, and stop in the middle of the screen or table, along with highlights around each of the die among the player's rolled dice 144, as shown in FIG. 29B. Since the dice game is now in play mode, the controller 12 may check for matches first, one die at a time, and may highlight each die to indicate matches and non-matches. In play mode, a match may result in a win, so matched dice may be highlighted in green and unmatched die may be highlighted in red, although other colors or no colors but different forms of highlighting may be used, such as the dash/dot lines around non-matched die in FIG. 29B. As illustrated in FIG. 29B, as none of the player's rolled dice 144 match the dealer's rolled die 140, the player may have lost, which is indicated by the X 148 above the first round box 121.

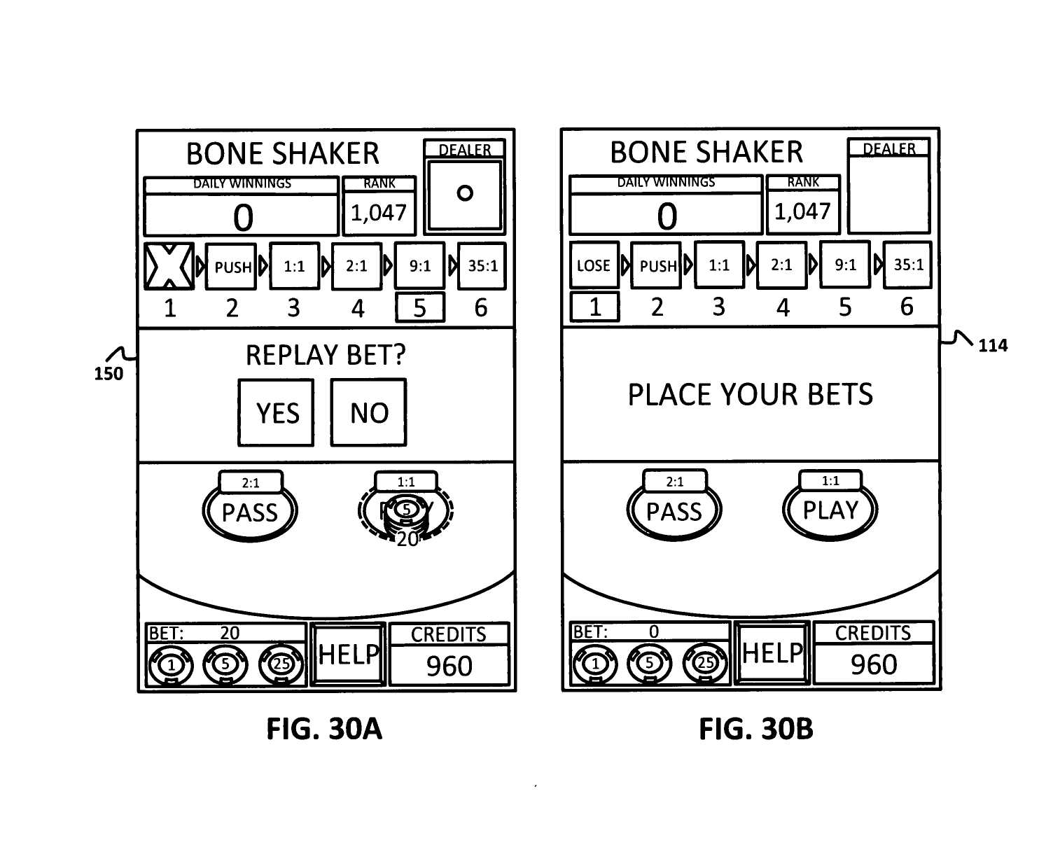

Upon completion of a round of play mode, the player may be presented with a replay prompt 150, as shown in FIG. 30A. Selecting yes from the replay prompt 150 may cause the same bet amount to be replayed, while selecting no from the replay prompt 150 may cause the place your bet prompt 114 of FIG. 30B to be displayed again. If the player lost in round 1, the player may be presented with the option of replaying the bet or making a new bet as previously described, but if the player won in round 1, the play mode of play may continue. As noted in FIG. 30B, the odds for rounds 1 and 2 may be lose and push respectively, so a player may not win any points as a result of a win in either of those two rounds. If the player wins in round 1, then the player may get to play round 2 and may get to keep the bet that was made in round 1. Likewise, in round 2, if the player wins, the player may push, meaning the player may keep the bet, and may move on to round 3.

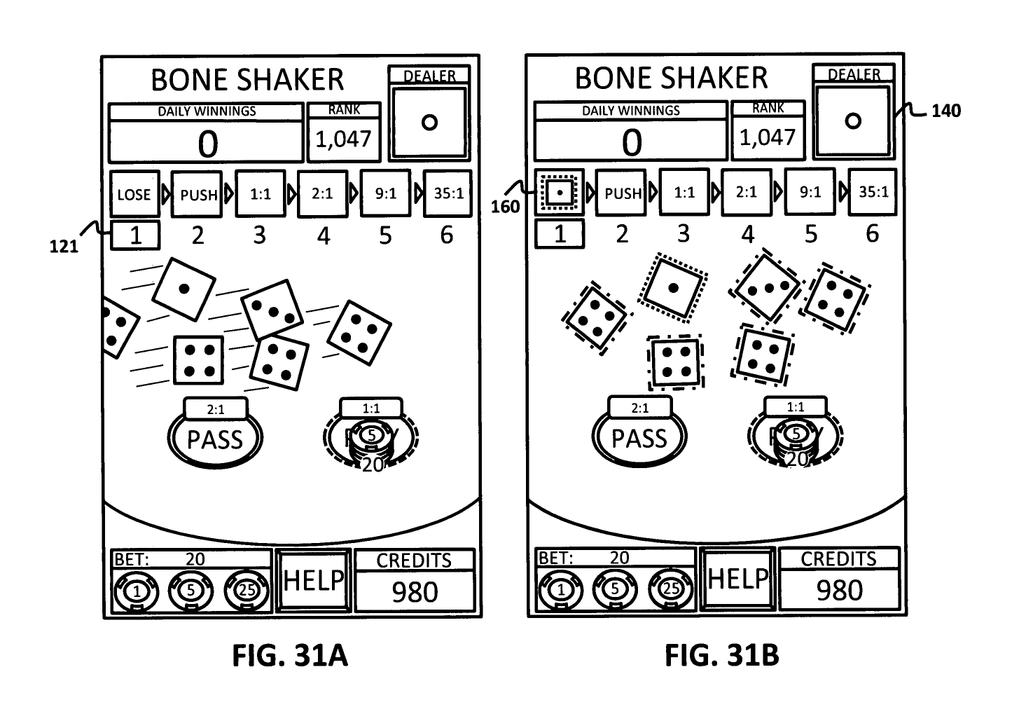

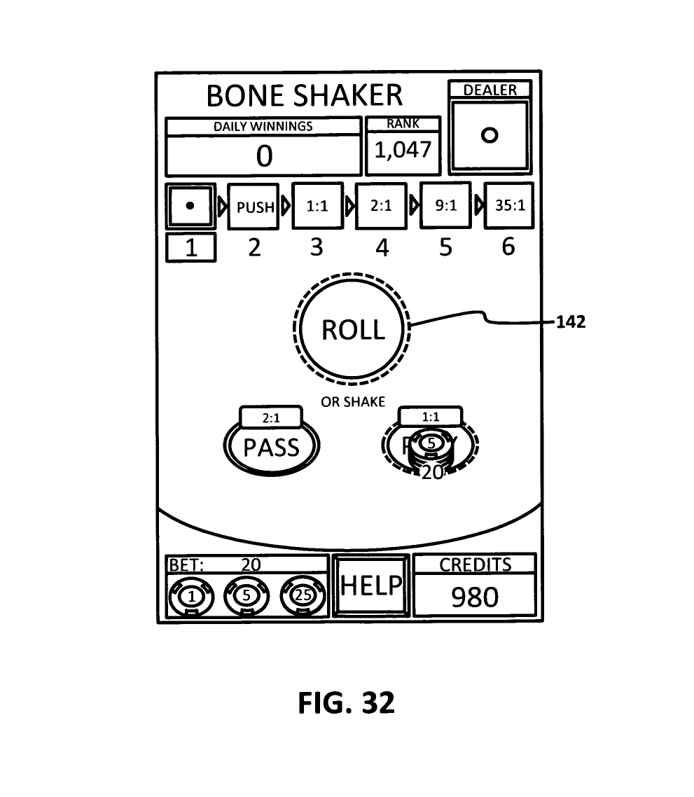

As illustrated in FIG. 31A, the play mode of round 1 would result in 6 dice being rolled by the player. If the player had a match of at least one die in round 1, a highlighted die 160 indicating the match in round 1 would initially be illustrated above the round box 121, as shown in FIG. 31B. The highlighted die 160 could be animated so as to grow and shrink in size, dance around, or perform some other form of action, as well as have sound generated along with the highlighting, to indicate a match. As the results of winning round 1 is to get to play round 2, the roll button 142 as illustrated in FIG. 32 is once again illustrated. The player may not have the option of changing a bet between rounds, but could have such an option, as long as the bet remains above 0. Touching the roll button 142 or shaking the mobile device will initiate the second round. The dealer's rolled die 140 may remain the same for each subsequent round, but in embodiments, the dealer's rolled die 140 could be rerolled before each new round.

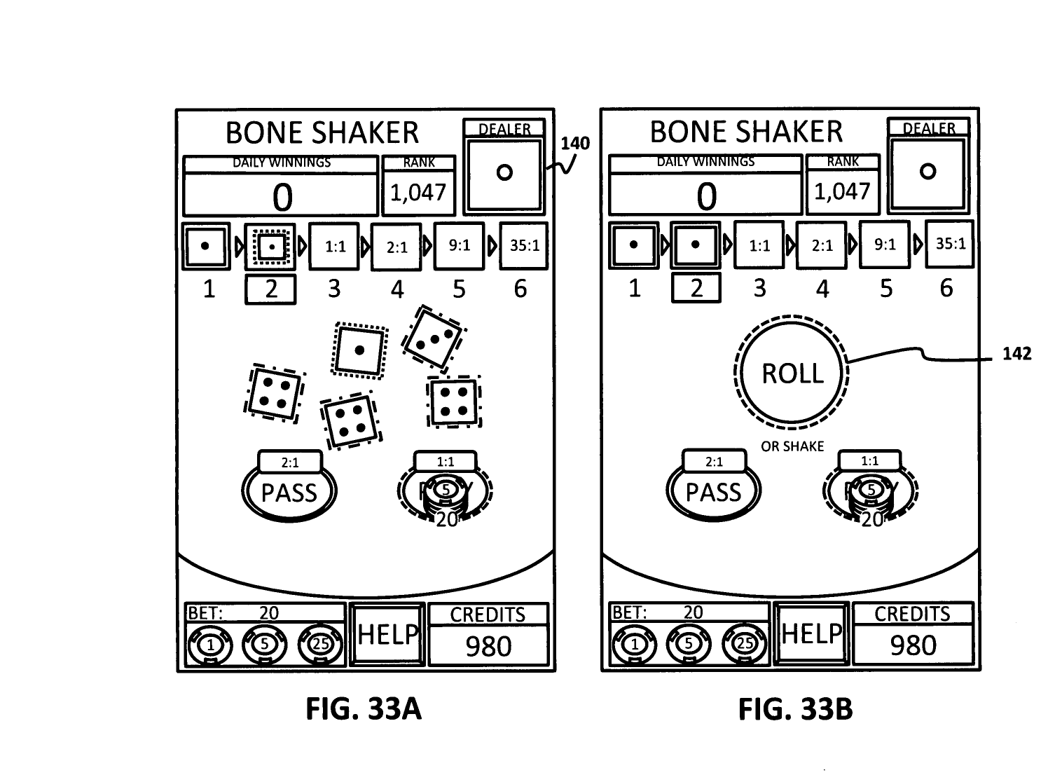

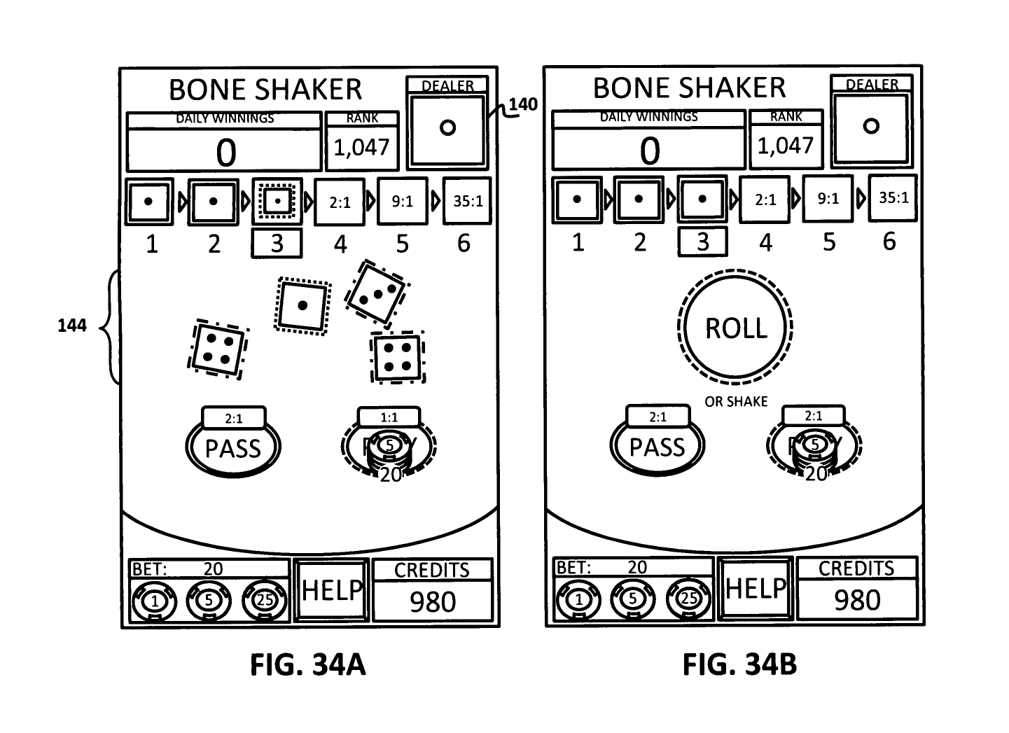

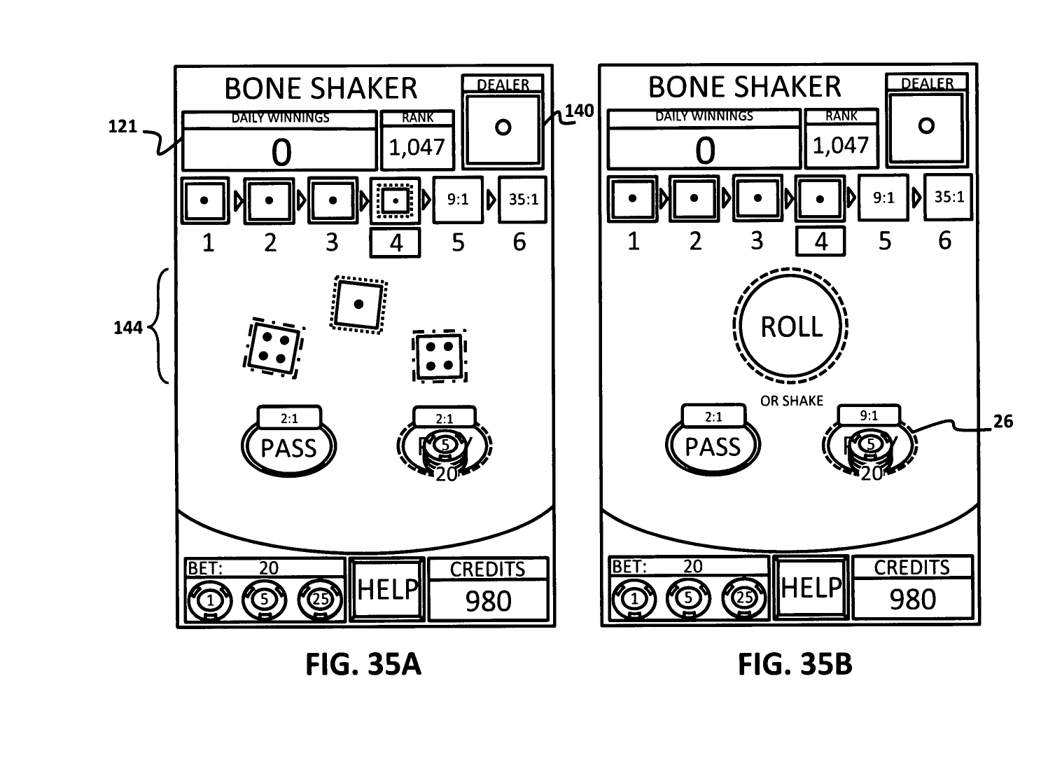

In round 2, the number of the player's rolled dice 144 may be reduced to 5 die, so FIG. 33A illustrates the 5 die rolled by the player, one of which matches the dealer's rolled die 140, thereby resulting in a win in round 2. A highlighted die 160 indicting the match in round 2 is illustrated above the round box 121 corresponding to round 2. As the odds for round two may be a push, the player may keep the bet and move to round 3, which may be activated by touching the roll button 142 of FIG. 33B. FIGS. 34A and 34B illustrate round 3 in which the player once again had a player rolled die 144 match the dealer's rolled die 140. In round 3, the odds are 1:1 so if the player wins round 3, the player wins an amount of points equal to the bet, which may be paid at the end of the play mode. In round 4, as illustrated by FIGS. 35A and 35B, only 3 die are rolled for the player rolled dice 144. If the player wins, the win is indicated above the round 4 round box 121, the bet may be paid 2:1 and may be collected until the end of the play mode, but the odds for round 5 may move to 9:1, as indicated above the bet in the play area 26.

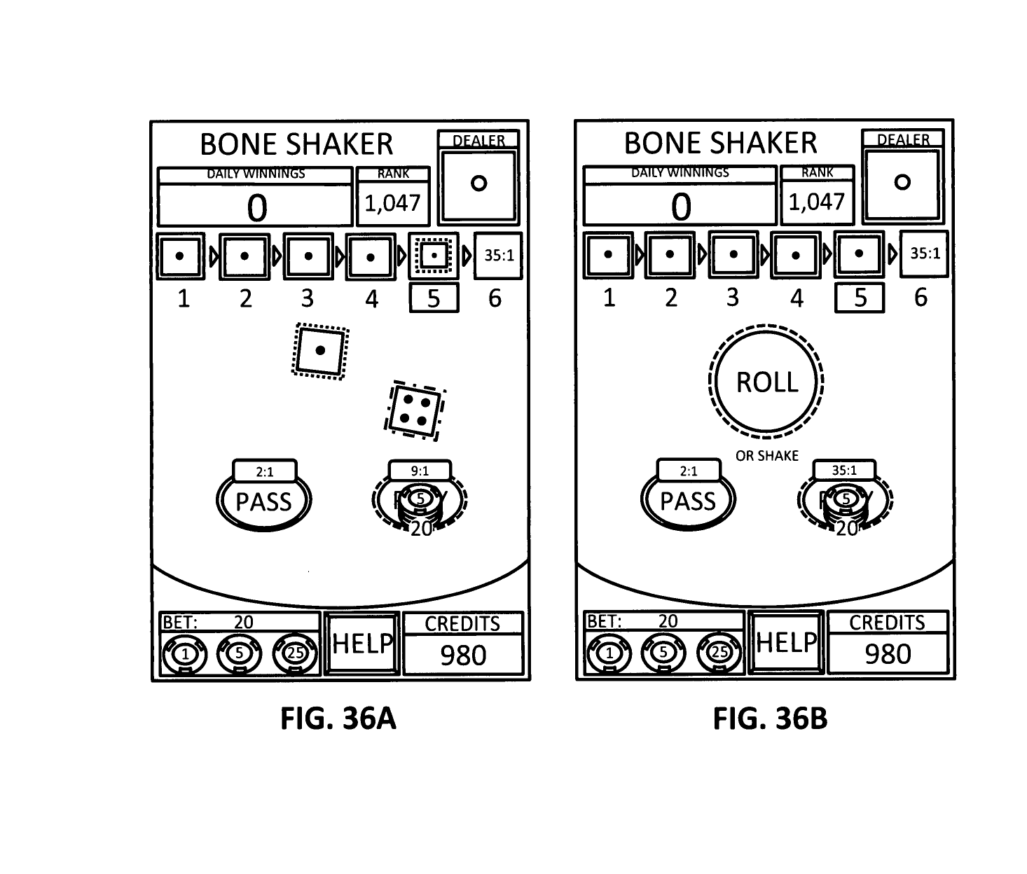

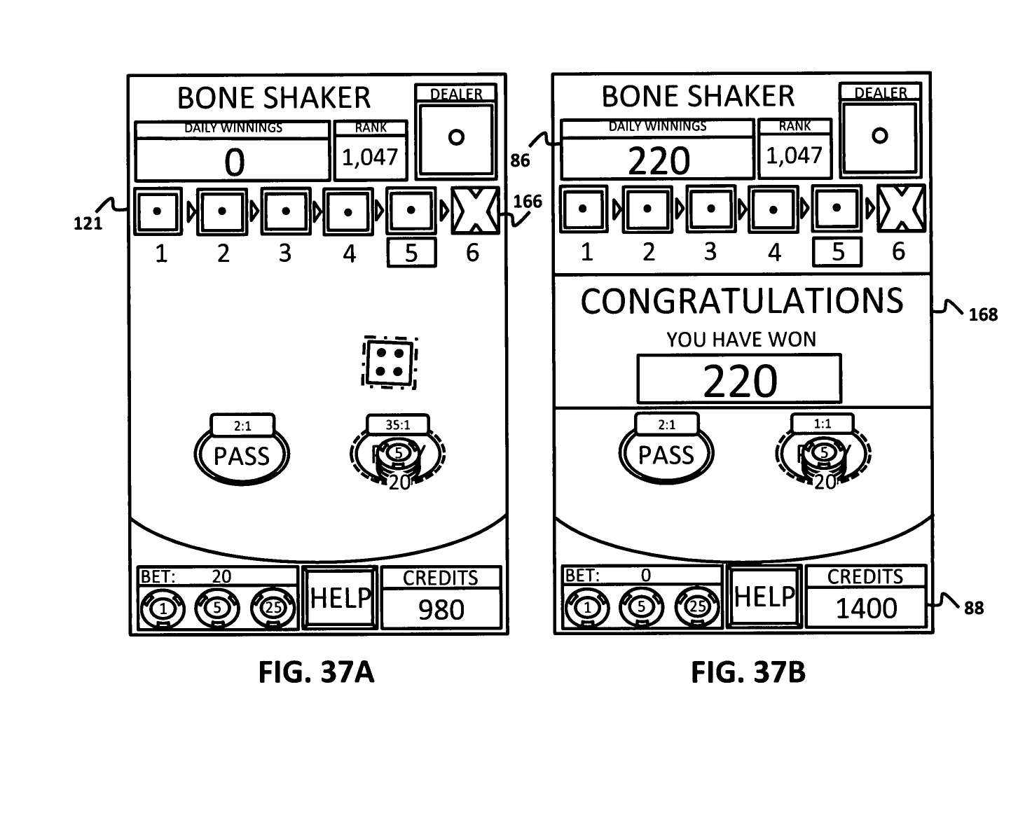

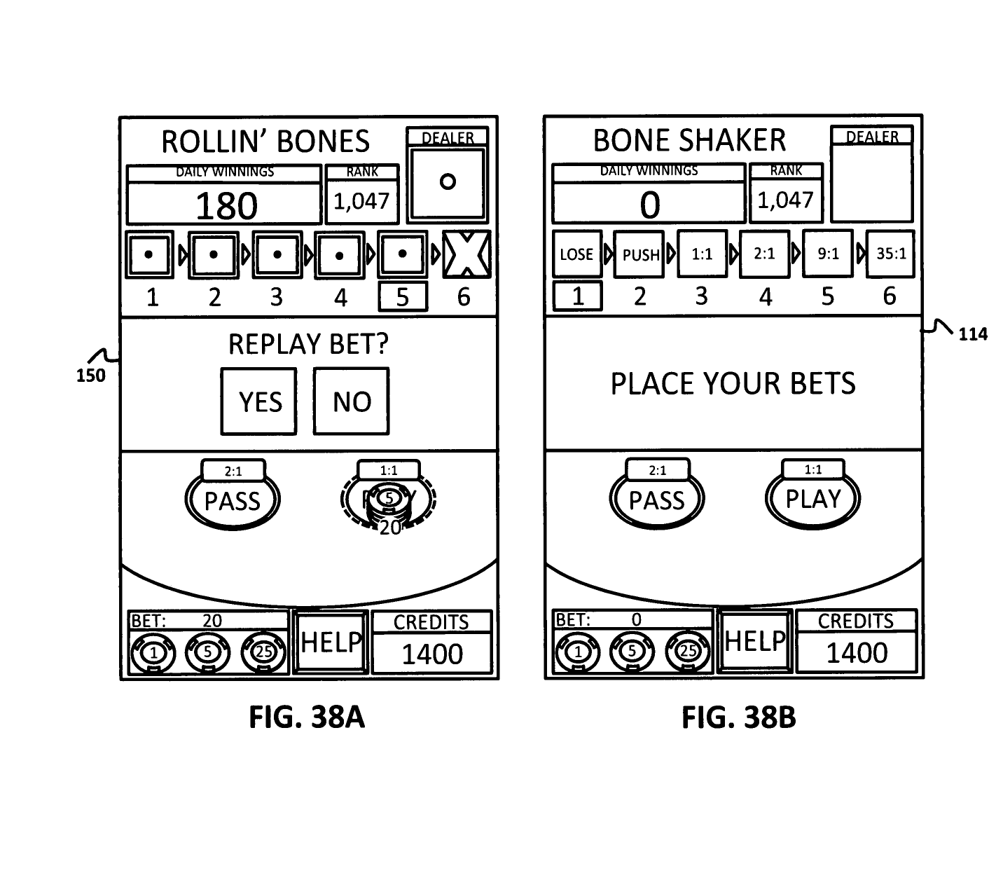

Round 5 is illustrated in FIGS. 36A and 36B, in which two die are rolled by the player, resulting in another win. In Round 6, in which the odd may move to 35:1, the player only rolls one die, but as illustrated in FIGS. 37A and 37B, there was no match so the player loses the round, which is indicated by the X 166 above the round 6 round box 121. However, since the player won no points in round 1, pushed in round 2, made 20 points in round 3, made 40 points in round 4, and made 180 points in round 5, but lost 20 points in 6, in FIG. 37B, a total of 220 points is awarded the player via the congratulations prompt 168. In an embodiment, the payout may be calculated based only on the last roll completed, versus an accumulation of all rolls successfully completed. Accordingly, under such an embodiment, the payout would have only been 180 points, based on the win in round 5. The daily winnings box 86 is updated to include the amount of point won, as is the credits 88. Upon completion of the play mode of play, the player may be presented with a replay prompt 150 again, as shown in FIG. 38A. Selecting yes from the replay prompt 150 may cause the same bet amount to be replayed, while selecting no from the replay prompt 150 may cause the place your bet prompt 114 of FIG. 38B to be displayed again.

Although the odds for the play mode are described above as round 1 (lose or push), round 2 (lose or push), round 3 (lose or 1:1), round 4 (lose or 2:1), round 5 (lose or 9:1) and round 6 (lose or 35:1), other odds may be used in place of these odds, which may depend on the operator of the game. A game for fun could have any odds without significant consequence, but if the dice game is used in a casino environment, the odds may need to be carefully chosen as to provide some degree of winning percentage that favors the casino, less the game become unprofitable.

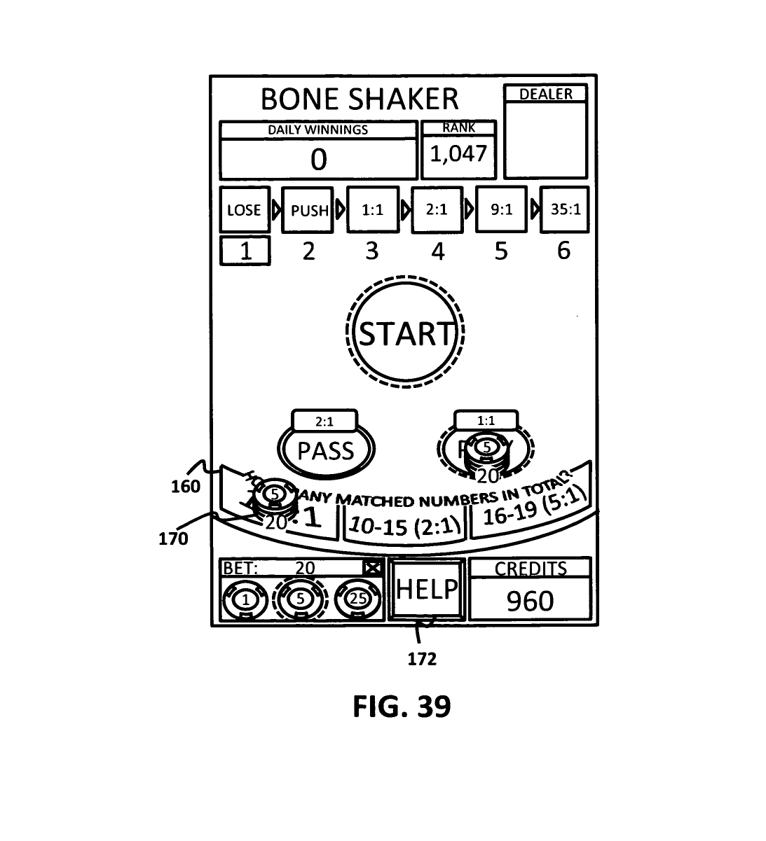

Side bets 160 are now described with reference to FIG. 39. If a player has selected the play mode of play, side bets 160 may be possible. A side bet 160 may enable a player to predict how many matching dice they think they will have after 6 round or however many rounds they make it through. Only a single side bet 160 may be selected. The side bets 160 may only be visible after a player selects play and disappear if the player selects pass. If a specific side bet 160 is chosen the side bet may be highlighted in some manner and chip images 170 corresponding to the bet are placed over the side bet 160. Side bets 160 may be selected in the same manner as pass or play bets. The side bets may be based on groupings of 1-9 matches, 10-15 matches and 16-19 matches, or some other groupings. Odds may be associated with each grouping, such as 1:1 odds for 1-9 matches, 2:1 odds for 10-15 matches, and 5:1 odds for 16-matches, although different odds could be selected by the operator. The help button 172 may provide a player with help throughout game play, including explanations and examples of how to play the dice game, except during play mode when a side bet has been placed, at which time the help button 172 becomes a simple counter, like credits 88, that tracks the side bets. Operation of the game mode when a side bet 160 is in place may otherwise be the same as when play mode is normally selected.

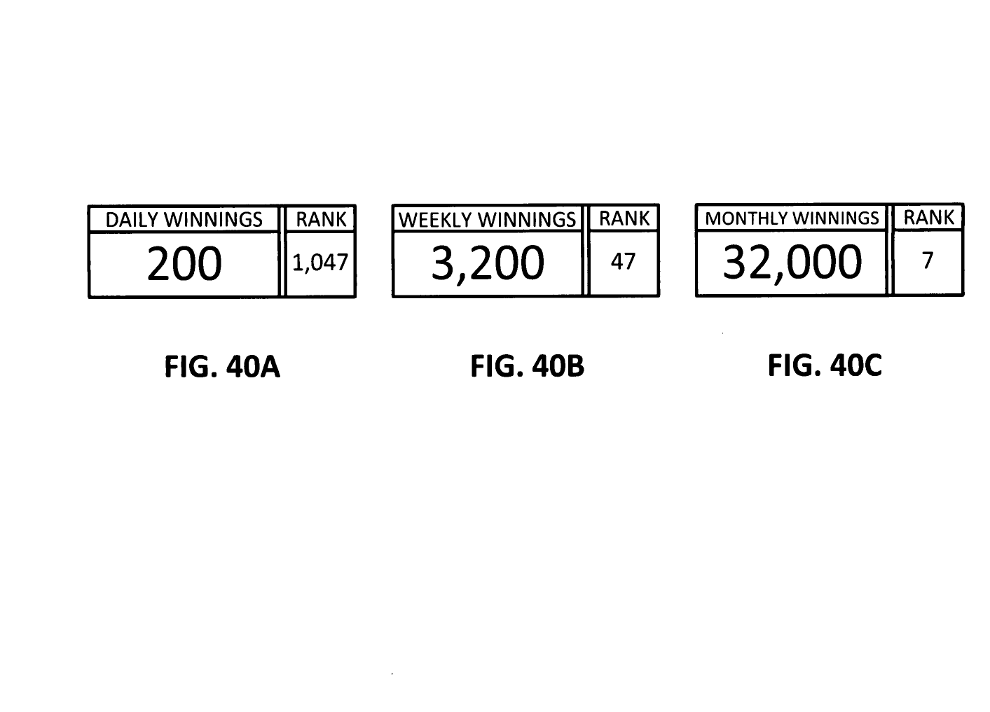

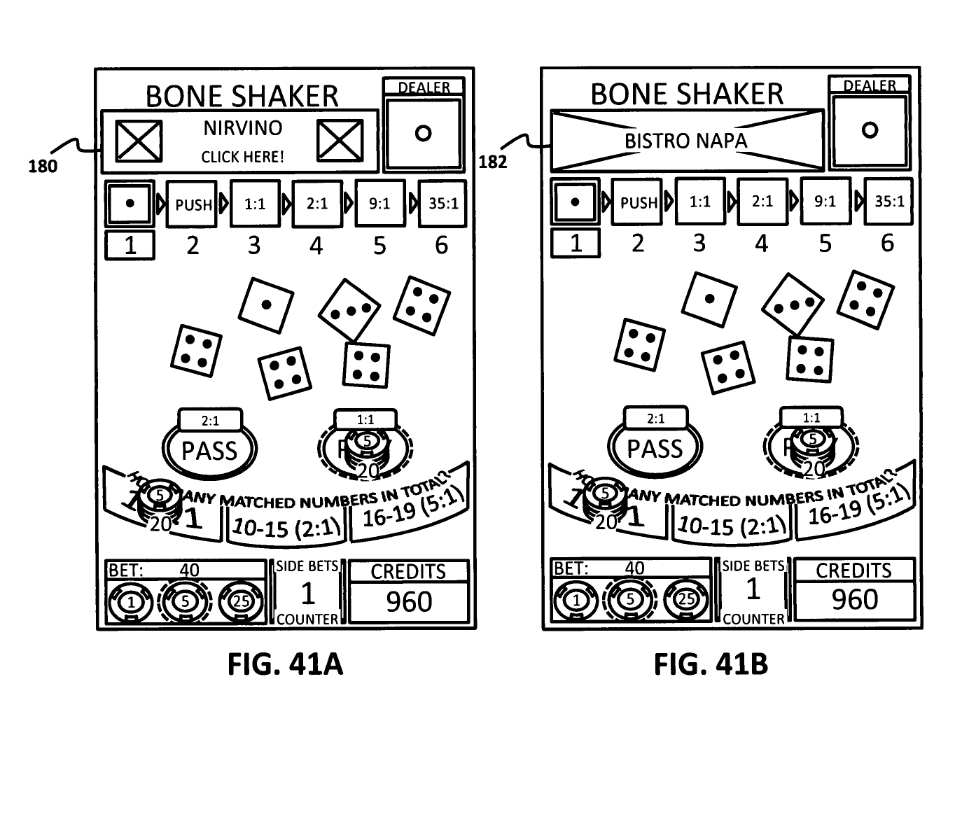

FIGS. 40A, 40B and 40C illustrate information boxes that may be displayed as daily winnings box 86 or other information boxes, which may include some total amount of points won by the player on a daily, weekly or monthly basis, and the players rank, based on those points, relative to any other active players. Selecting a rank may drop down a list of all other ranked players, or a top list of players. As illustrated in FIGS. 41A and 41B, the information boxes may also be used for other purposes, such as advertising for other games, applications, or services, such as the advertisement 180 for an mobile device application or the advertisement 182 for a restaurant at a casino. The advertisements may be static or interactive. An interactive advertisement may allow a user to touch or otherwise select the advertisement and be provided with additional information, directed to a website or other location associated with the advertiser, receive a discount coupon, etc.

The dice game only requires a single player, which can be both the player and the dealer, although a competitive game requires one person to be the player and one person to be the dealer, which persons can switch as desired to play different roles. Any number and type of dice greater than two can be used. The die can be of any shape, size or design and marked with numbers, pips, indicia, colors or in any other suitable manner, herein referred to as “points”, so as to distinguish one face of a die from another face of a die. In an embodiment, the number of dice used by a player in the play mode correlates to the number of possible rounds of play, so that one die can be removed after each round.

Although the match number is described above as being generated by the dealer, the match number could be generated by the player and the dealer could then try to match or not match the match number, with the player betting on the dealer's rolls and being paid based on what the dealer does or does not do. Also, while only a single player is described above as playing at one time, in embodiments, multiple players can play at once and while one or more players are play in play mode, other players could play each round in pass mode. The terms “play” and “pass” are just terms of convenience used for identification purposes herein and are not limiting in any way. Other terms could be used to refer to the different modes of play without changing the dice game in any material manner.

Some examples of different types of play mode bets are as follows:

### Example 1

One DEALER and one PLAYER, using 1 MATCH DIE and 6 GAME DICE (Using standard 6-sided dice, each marked 1 through 6). SET UP: The DEALER has 1 MATCH DIE, and the PLAYER has 6 GAME DICE. The table has two betting boxes in front of the PLAYER; one marked “PLAY” and one marked “PASS”. GAME PLAY: The PLAYER places a wager on “PLAY”. The DEALER rolls his die to start the game. In this case he rolled a 5.
ROUND 1: The PLAYER rolls all six dice, 2 of which were 5's, only ONE die showing a 5 is removed from play.
ROUND 2: The PLAYER rolls the remaining five dice, and rolls another 5, so that die is removed from play.
ROUND 3: The PLAYER rolls the remaining four dice. This time he rolls three 5's, and ONE more is removed from play.
ROUND 4: The PLAYER rolls the remaining three dice. The player rolls no 5's this round, so he is credited for successfully completing the third round and the GAME is over.

### Example 2

One DEALER and four PLAYERS, using 6 GAME DICE, and 4 MATCH DICE. (Using standard 6-sided dice, each marked 1 through 6). SET UP: Each player has 1 MATCH DIE, the dealer has 6 GAME DICE (DEALER can have optional “MARKERS”, one of each number (1-6) for each player). The table has two “BETTING BOXES” in front of each player; one marked “Play” and one marked “Pass”. GAME PLAY: Each player starts by placing a bet on the Play, Pass or both betting boxes. Once all bets have been placed, each player rolls their die, starting with the player to the dealers left and going clockwise around the table. In this example, the DEALER replaces each PLAYER'S MATCH DIE with a MARKER bearing the same number to ensure that the number showing on the MATCH DIE is not changed. PLAYER 1 and PLAYER 2 rolled 5's, PLAYER 3 rolled a 3, PLAYER 4 rolled a 6.
ROUND 1: The DEALER rolls all six dice: 1, 2, 3, 5, 6, 6. PLAYERS 3 had no match, so he is eliminated.
ROUND 2: One die is removed from play and the DEALER rolls the remaining five dice: 2, 3, 3, 4, 5. PLAYER 4 had no match so he is eliminated but is credited for completing ROUND 1.
ROUND 3: One die is removed from play and the DEALER rolls the remaining four dice: 1, 3, 4, 5.
ROUND 4: One die is removed from play and the DEALER rolls the remaining three dice: 2, 3, 6. PLAYERS 1 and 2 are credited for successfully completing ROUND 3, and the GAME is over.

### Example 3

One DEALER and three PLAYERS, using 6 GAME DICE, and a GAME TABLE with BETTING BOXES marked 1 through 8, and a “PASS” or “PLAY” section on each BETTING BOX (Using 8-sided dice, each marked 1 through 8). SET UP: There are six GAME DICE, which the DEALER will pass around the table, starting to his left, and giving each PLAYER the opportunity to roll the GAME DICE either for one ROUND or one complete GAME. GAME PLAY: Each PLAYER starts by placing a bet on the number they wish and “PLAY”, “PASS” or both betting boxes. Once all bets have been placed the DEALER passes the GAME DICE to the first PLAYER to roll. PLAYER 1 bet #8 “PASS” and #4 “PLAY”, PLAYER 2 bet #5 “PLAY” and PLAYER 3 bet #1 “PASS” and #1 “PLAY”.
ROUND 1: The PLAYER 1 rolls all six dice—RESULTS: 2, 4, 5, 6, 6, 8. PLAYER 1 forfeits his “PASS” bet on #4, and PLAYER 3 is credited for winning his “PASS” bet on #1, forfeits his “PLAY” bet on #1, and is out of the GAME.
ROUND 2: One die is removed from play and PLAYER 1 rolls the remaining five dice—RESULTS: 1, 3, 4, 7, 8. PLAYER 2 forfeits his “PLAY” bet on #5, is credited for successfully completing ROUND 1, and is out of the GAME.
ROUND 3: One die is removed from play and PLAYER 1 rolls the remaining four dice—RESULTS: 2, 2, 6, 8. PLAYER 1 forfeits his “PLAY” bet on #4, is credited for successfully completing ROUND 2, and is out of the GAME.

Some examples of different types of pass mode bets are as follows:

### Example 1

One COMPUTER DEALER and one PLAYER, using 6 GAME DICE and a VIDEO GAME TABLE (Using standard 6-sided dice, each marked 1 through 6). SET UP: The table has numbered “Betting Boxes” that match the numbers on the dice. Each number has a “PASS” and a “PLAY” Betting Box. And the COMPUTER DEALER has 6 GAME DICE. GAME PLAY: The PLAYER places a wager on Number 5 and “PASS”.
ROUND: The DEALER rolls all six dice, 1 of which was a 5, the PLAYER loses his bet and his game is over.

### Example 2

One DEALER and two PLAYERS, using 6 GAME DICE and a GAME TABLE (Using standard 6-sided dice, each marked 1 through 6). SET UP: The table has numbered “Betting Boxes” that match the numbers on the dice. Each number has a “PASS” and a “PLAY” Betting Box. And the DEALER has 6 GAME DICE. GAME PLAY: PLAYER 1 places a wager on the Number 4 and “PASS”, PLAYER 2 places a wager on the Number 5 and “PLAY”.
ROUND 1: The DEALER rolls all six dice—RESULTS: 2, 2, 3, 5, 5, 6. PLAYER 1 is paid for his wager and his GAME is over. PLAYER 2 proceeds to the next ROUND.
ROUND 2: One die is removed from play and the remaining five GAME DICE are rolled—RESULTS: 2, 4, 5, 6, 6.
ROUND 3: One die is removed from play and the remaining four GAME DICE are rolled—RESULTS: 1, 3, 4, 5.
ROUND 4: One die is removed from play and the remaining three GAME DICE are rolled—RESULTS: 1, 5, 6.
ROUND 5: One die is removed from play and the remaining two GAME DICE are rolled—RESULTS: 2, 5.
ROUND 6: One die is removed from play and the last GAME DIE is rolled—RESULTS: 5. PLAYER 2 is paid for completing all 6 ROUNDS.

Additional embodiments of the dice game include a two person version where the dealer has one die and rolls it to start the game, then the player rolls the GAME DICE for ROUNDS of six, five, four etc. pulling out 1 matching die per round. Betting embodiments include additional side bet, such as bets on rolling on rolling all of the same number on particular rolls, or bets on the total number of dice that match the players die (or the dealer's in a reverse game), or bets on rolling dice that can create a “poker-style hand” such as a four of a kind or full house, etc. A player who has won the last round may also have the option to go double or nothing on anything won in the prior round. To double down on a bet, the player may keep the original bet and all his winnings in the betting box, and the dealer may roll two dice. If one of the dealers two dice match the player's die he doubles his payoff.

When played in a table version of the game, the dice game can be played on a table with the player placing his pass or play bets on a number rather than a dealer rolling a number. This can be accomplished with the numbers appearing on the board with a “Pass” and “Play” box for each number.

While embodiments have been described in which a specific number of dice are rolled per round, the dice game on does not depend on playing a specific number of rolls per round or rounds per game. In general the game is played by matching a single die to a predetermined number, symbol, or other distinguishing mark. In general the game starts with a particular number of game dice, and a single game die is removed from play every time one or more dice matches the predetermined target number, symbol, or distinguishing mark. However, that does not prevent a variation such as rolling a particular number of dice more than one time in a round, or adding or subtracting rounds of play from a game. The dice game can even be played in reverse, where one or more person(s) roll one game die first, if the die matches the match die, the game continues in the same fashion with one die being added to the roll each round. Odds and winning would be calculated accordingly.

In an embodiment of the dice game, the embodiment comprising at least one first player die of a type having a plurality of faces with each face representing a different point and configured to be rolled by a first player to create a match point; at least two second player dice, each of the second player die of the type, configured to be rolled by a second player so that each second player die either matches or does not match the match point; a user interface configured to enable the second player to select a first mode of play or a second mode of play, the first mode including a single round in which the second player rolls all of the second player dice and wins if no second player die matches the match point, the second mode including a set number of rounds in which the second player wins a round among the set number of rounds if the second player rolls available die among the second player dice during the round and at least one second player die matches the match point, the available die in a first round of the second mode being equal to the at least two second player dice and the available die decreasing by one die for each round after the first round, the second mode continuing until the second player has won each round among the set number of rounds or none of the available die match the match point during any of the rounds.

In the embodiment, wherein the user interface is further configured to enable the second player to place a bet, having predetermined payoff odds, on the outcome of the first mode of play or the second mode of play.

In the embodiment, wherein the predetermined payoff odds increase from one round to a next round for at least some of the rounds among the set number of rounds.

In the embodiment, wherein the user interface is further configured to enable the second player to play one or more side bets, each having predetermined payoff odds, based on the available die rolled during one or more rounds among the set number of rounds.

In the embodiment, wherein the predetermined payoff odds increase as the number of die among the available die rolled in one or more rounds match the match point.

In the embodiment, wherein the second player is awarded points for each round won in the first mode and the second mode.

In the embodiment, wherein the awarded points increase from one round to a next round for at least some of the rounds among the set number of rounds.

In the embodiment, wherein the second player is awarded points for actions other than winning rounds in the first mode or the second mode.

In the embodiment, wherein the dice game further comprises a physical surface upon which the dice game is played.

In the embodiment, wherein the dice game further comprises a controller configured to control the user interface and randomly generating the match point when rolled by the first player and the second player dice when rolled by the second player, and a non-transitory storage medium for storing data generated by the first player and the second player and generated during the first mode and the second mode.

In the embodiment, wherein the dice game further includes machine readable instructions configured to be stored in the non-transitory storage medium and configured to instruct the controller on at least the control of the user interface and the first player dice and the second player dice.

In the embodiment, wherein the controller, the non-transitory storage medium and the user interface are within a mobile device and the machine readable instructions are an application configured to operate on the mobile device.

In the embodiment, wherein the controller is further configured to connect to a software application or an electronic service other than the dice game and to share data stored in the non-transitory storage medium with the software application or the electronic service.

In the embodiment, wherein the user interface includes a user interactive electronic display.

In the embodiment, wherein the user interface includes one or more advertisements with which the second player can interact.

In the embodiment, wherein the controller, the non-transitory storage medium and the user interface are within a gaming table.

In the embodiment, wherein the controller, the non-transitory storage medium and the user interface are within a slot machine.

In the embodiment, wherein the first player is fully simulated by the controller and the user interface and second player is partially simulated by the controller and the user interface.

In the embodiment, wherein the second player is a person, wherein the user interface is physically located with the second player, and wherein the controller and the non-transitory storage medium is not physically located with the second player.

In the embodiment, wherein the user interface is incorporated into a gaming table.

In an embodiment of a system for operating a dice game, the embodiment comprising: a computer processor; and a non-transitory storage medium in communication with the computer processor when the system is activated, the memory comprising computer readable instructions that upon execution by the computer processor cause the system to generate an image of at least one first player die of a type having a plurality of faces with each face representing a different point and configured to be rolled by a first player to create a match point, generate an image of at least two second player dice, each of the second player die of the type, configured to be rolled by a second player so that each second player die either matches or does not match the match point, and generate a user interface configured to enable the second player to select a first mode of play or a second mode of play, the first mode including a single round in which the second player rolls all of the second player dice and wins if no second player die matches the match point, the second mode including a set number of rounds in which the second player wins a round among the set number of rounds if the second player rolls available die among the second player dice during the round and at least one second player die matches the match point, the available die in a first round of the second mode being equal to the at least two second player dice and the available die decreasing by one die for each round after the first round, the second mode continuing until the second player has won each round among the set number of rounds or none of the available die match the match point during any of the rounds.

In the embodiment, wherein the user interface is further configured to enable the second player to place a bet, having predetermined payoff odds, on the outcome of the first mode of play or the second mode of play.

In the embodiment, wherein the predetermined payoff odds increase from one round to a next round for at least some of the rounds among the set number of rounds.

In the embodiment, wherein the user interface is further configured to enable the second player to play one or more side bets, each having predetermined payoff odds, based on the available die rolled during one or more rounds among the set number of rounds.

In the embodiment, wherein the predetermined payoff odds increase as the number of die among the available die rolled in one or more rounds match the match point.

In the embodiment, wherein the computer readable instructions cause the system to awarded points to the second player for each round won in the first mode and the second mode.

In the embodiment, wherein the awarded points increase from one round to a next round for at least some of the rounds among the set number of rounds.

In the embodiment, wherein the computer readable instructions cause the system to award the second player points for actions other than winning rounds in the first mode or the second mode.

In an embodiment of a computer-implemented method for operating a dice game, the embodiment comprising the steps of generating an image of at least one first player die of a type having a plurality of faces with each face representing a different point and configured to be rolled by a first player to create a match point; generating an image of at least two second player dice, each of the second player die of the type, configured to be rolled by a second player so that each second player die either matches or does not match the match point; and generating a user interface configured to enable the second player to select a first mode of play or a second mode of play, the first mode including a single round in which the second player rolls all of the second player dice and wins if no second player die matches the match point, the second mode including a set number of rounds in which the second player wins a round among the set number of rounds if the second player rolls available die among the second player dice during the round and at least one second player die matches the match point, the available die in a first round of the second mode being equal to the at least two second player dice and the available die decreasing by one die for each round after the first round, the second mode continuing until the second player has won each round among the set number of rounds or none of the available die match the match point during any of the rounds.

In the embodiment, wherein the user interface is further configured to enable the second player to place a bet, having predetermined payoff odds, on the outcome of the first mode of play or the second mode of play.

In the embodiment, wherein the predetermined payoff odds increase from one round to a next round for at least some of the rounds among the set number of rounds.

In the embodiment, wherein the user interface is further configured to enable the second player to play one or more side bets, each having predetermined payoff odds, based on the available die rolled during one or more rounds among the set number of rounds.

In the embodiment, wherein the predetermined payoff odds increase as the number of die among the available die rolled in one or more rounds match the match point.

In the embodiment, further comprising the step of awarding points to the second player for each round won in the first mode and the second mode.

In the embodiment, wherein the awarded points increase from one round to a next round for at least some of the rounds among the set number of rounds.

In the embodiment, further comprising the step of awarding the second player points for actions other than winning rounds in the first mode or the second mode.

In the embodiment of a dice game, the embodiment comprising: means for generating an image on a display of a computer of at least one first player die of a type having a plurality of faces with each face representing a different point; means for rolling the first player die to create a match point for display on the display; means for generating an image of at least two second player dice on the display, each of the second player die of the type; means for rolling the second player dice so that each second player die either matches or does not match the match point; means for generating a user interface on the display; and means for enable the second player to select a first mode of play or a second mode of play through the user interface, the first mode including a single round in which the second player rolls all of the second player dice and wins if no second player die matches the match point, the second mode including a set number of rounds in which the second player wins a round among the set number of rounds if the second player rolls available die among the second player dice during the round and at least one second player die matches the match point, the available die in a first round of the second mode being equal to the at least two second player dice and the available die decreasing by one die for each round after the first round, the second mode continuing until the second player has won each round among the set number of rounds or none of the available die match the match point during any of the rounds.

Reference throughout this specification to “one example,” “an example,” and/or “another example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

What is claimed:

1. A dice game, comprising:
at least one first player die of a type having a plurality of faces with each face representing a different point and configured to be rolled by a first player to create a match point;
at least two second player dice, each of the second player die of the type, configured to be rolled by a second player so that each second player die either matches or does not match the match point;
a user interface configured to enable the second player to select a first mode of play or a second mode of play, the first mode including a single round in which the second player rolls all of the second player dice and wins if no second player die matches the match point, the second mode including a set number of rounds in which the second player wins a round among the set number of rounds if the second player rolls available die among the second player dice during the round and at least one second player die matches the match point, the available die in a first round of the second mode being equal to the at least two second player dice and the available die decreasing by one die for each round after the first round, the second mode continuing until the second player has won each round among the set number of rounds or none of the available die match the match point during any of the rounds.

2. The dice game as recited in claim 1, wherein the user interface is further configured to enable the second player to place a bet, having predetermined payoff odds, on the outcome of the first mode of play or the second mode of play.

3. The dice game as recited in claim 2, wherein the predetermined payoff odds increase from one round to a next round for at least some of the rounds among the set number of rounds.

4. The dice game as recited in claim 2, wherein the user interface is further configured to enable the second player to play one or more side bets, each having predetermined payoff odds, based on the available die rolled during one or more rounds among the set number of rounds.

5. The dice game as recited in claim 4, wherein the predetermined payoff odds increase as the number of die among the available die rolled in one or more rounds match the match point.

6. The dice game as recited in claim 1, wherein the second player is awarded points for each round won in the first mode and the second mode.

7. The dice game as recited in claim 6, wherein the awarded points increase from one round to a next round for at least some of the rounds among the set number of rounds.

8. The dice game as recited in claim 6, wherein the second player is awarded points for actions other than winning rounds in the first mode or the second mode.

9. The dice game as recited in claim 1, wherein the dice game further comprises a physical surface upon which the dice game is played.

10. The dice game as recited in claim 1, wherein the dice game further comprises a controller configured to control the user interface and randomly generating the match point when rolled by the first player and the second player dice when rolled by the second player, and a non-transitory storage medium for storing data generated by the first player and the second player and generated during the first mode and the second mode.

11. The dice game as recited in claim 10, wherein the dice game further includes machine readable instructions configured to be stored in the non-transitory storage medium and configured to instruct the controller on at least the control of the user interface and the first player dice and the second player dice.

12. The dice game as recited in claim 11, wherein the controller, the non-transitory storage medium and the user interface are within a mobile device and the machine readable instructions are an application configured to operate on the mobile device.

13. The dice game as recited in claim 10, wherein the controller is further configured to connect to a software application or an electronic service other than the dice game and to share data stored in the non-transitory storage medium with the software application or the electronic service.

14. The dice game as recited in claim 10, wherein the user interface includes a user interactive electronic display.

15. The dice game as recited in claim 10, wherein the user interface includes one or more advertisements with which the second player can interact.

16. The dice game as recited in claim 10, wherein the controller, the non-transitory storage medium and the user interface are within a gaming table.

17. The dice game as recited in claim 10, wherein the controller, the non-transitory storage medium and the user interface are within a slot machine.

18. The dice game as recited in claim 10, wherein the first player is fully simulated by the controller and the user interface and second player is partially simulated by the controller and the user interface.

19. The dice game as recited in claim 10, wherein the second player is a person, wherein the user interface is physically located with the second player, and wherein the controller and the non-transitory storage medium is not physically located with the second player.

20. The dice game as recited in claim 1, wherein the user interface is incorporated into a gaming table.

21. A system for operating a dice game, comprising:
a computer processor; and
a non-transitory storage medium in communication with the computer processor when the system is activated, the memory comprising computer readable instructions that upon execution by the computer processor cause the system to generate an image of at least one first player die of a type having a plurality of faces with each face representing a different point and configured to be rolled by a first player to create a match point, generate an image of at least two second player dice, each of the second player die of the type, configured to be rolled by a second player so that each second player die either matches or does not match the match point, and generate a user interface configured to enable the second player to select a first mode of play or a second mode of play, the first mode including a single round in which the second player rolls all of the second player dice and wins if no second player die matches the match point, the second mode including a set number of rounds in which the second player wins a round among the set number of rounds if the second player rolls available die among the second player dice during the round and at least one second player die matches the match point, the available die in a first round of the second mode being equal to the at least two second player dice and the available die decreasing by one die for each round after the first round, the second mode continuing until the second player has won each round among the set number of rounds or none of the available die match the match point during any of the rounds.

22. The system as recited in claim 21, wherein the user interface is further configured to enable the second player to place a bet, having predetermined payoff odds, on the outcome of the first mode of play or the second mode of play.

23. The system as recited in claim 22, wherein the predetermined payoff odds increase from one round to a next round for at least some of the rounds among the set number of rounds.

24. The system as recited in claim 22, wherein the user interface is further configured to enable the second player to play one or more side bets, each having predetermined payoff odds, based on the available die rolled during one or more rounds among the set number of rounds.

25. The system as recited in claim 24, wherein the predetermined payoff odds increase as the number of die among the available die rolled in one or more rounds match the match point.

26. The system as recited in claim 21, wherein the computer readable instructions cause the system to awarded points to the second player for each round won in the first mode and the second mode.

27. The system as recited in claim 26, wherein the awarded points increase from one round to a next round for at least some of the rounds among the set number of rounds.

28. The system as recited in claim 26, wherein the computer readable instructions cause the system to award the second player points for actions other than winning rounds in the first mode or the second mode.

29. A computer-implemented method for operating a dice game, comprising the steps of:
generating an image of at least one first player die of a type having a plurality of faces with each face representing a different point and configured to be rolled by a first player to create a match point;
generating an image of at least two second player dice, each of the second player die of the type, configured to be rolled by a second player so that each second player die either matches or does not match the match point; and
generating a user interface configured to enable the second player to select a first mode of play or a second mode of play, the first mode including a single round in which the second player rolls all of the second player dice and wins if no second player die matches the match point, the second mode including a set number of rounds in which the second player wins a round among the set number of rounds if the second player rolls available die among the second player dice during the round and at least one second player die matches the match point, the available die in a first round of the second mode being equal to the at least two second player dice and the available die decreasing by one die for each round after the first round, the second mode continuing until the second player has won each round among the set number of rounds or none of the available die match the match point during any of the rounds.

30. The method as recited in claim 29, wherein the user interface is further configured to enable the second player to place a bet, having predetermined payoff odds, on the outcome of the first mode of play or the second mode of play.

31. The method as recited in claim 30, wherein the predetermined payoff odds increase from one round to a next round for at least some of the rounds among the set number of rounds.

32. The method as recited in claim 30, wherein the user interface is further configured to enable the second player to play one or more side bets, each having predetermined payoff odds, based on the available die rolled during one or more rounds among the set number of rounds.

33. The method as recited in claim 32, wherein the predetermined payoff odds increase as the number of die among the available die rolled in one or more rounds match the match point.

34. The method as recited in claim 29, further comprising the step of awarding points to the second player for each round won in the first mode and the second mode.

35. The method as recited in claim 34, wherein the awarded points increase from one round to a next round for at least some of the rounds among the set number of rounds.

36. The method as recited in claim 34, further comprising the step of awarding the second player points for actions other than winning rounds in the first mode or the second mode.

37. A dice game, comprising:
means for generating an image on a display of a computer of at least one first player die of a type having a plurality of faces with each face representing a different point;
means for rolling the first player die to create a match point for display on the display;
means for generating an image of at least two second player dice on the display, each of the second player die of the type;
means for rolling the second player dice so that each second player die either matches or does not match the match point;
means for generating a user interface on the display; and
means for enable the second player to select a first mode of play or a second mode of play through the user interface, the first mode including a single round in which the second player rolls all of the second player dice and wins if no second player die matches the match point, the second mode including a set number of rounds in which the second player wins a round among the set number of rounds if the second player rolls available die among the second player dice during the round and at least one second player die matches the match point, the available die in a first round of the second mode being equal to the at least two second player dice and the available die decreasing by one die for each round after the first round, the second mode continuing until the second player has won each round among the set number of rounds or none of the available die match the match point during any of the rounds.
